(19) United States
(12) Patent Application Publication
(10) Pub. No.: US 2002/0146018 A1
(43) Pub. Date: Oct. 10, 2002

(54) System for providing wireless application protocol-based services

(76) Inventors: Kari Kailamaki, Espoo (FI); Sanjay Khurana, Reston, VA (US); Matti Suomalainen, Espoo (FI)

Correspondence Address: LOTT & FRIEDLAND, P.A., P.O. BOX 141098, CORAL GABLES, FL, 33114-1098, US

(21) Appl. No.: 09/860,411

(22) Filed: May 18, 2001

Related U.S. Application Data
(60) Provisional application No. 60/203,811, filed on May 19, 2000.

(51) Int. Cl. H04L 12/28

(52) U.S. Cl. 370/401; 370/252

(57) ABSTRACT

A computer-implemented system for providing access to Wireless Application Protocol (WAP)-based services by providing a Web-based Administration Console utilizing the WAP environment; providing a secure method to log in and access the WAP environment; enabling administrators to perform maintenance operations without interrupting users' access to the WAP environment; monitoring the status of all modules controlled by the Administration Console; monitoring events occurring within such Console; editing the configuration parameters of the Administration Console; managing those users or groups of users who access the WAP Environment via such Console; administering accounting functions associated with billing those users or groups of users who access the WAP Environment via such Console; establishing groups of users who access the WAP Environment via such Console; establishing of aliases accessible only by specific users or groups of users; and enabling service providers to add their services to those which are accessible to users who access the WAP Environment via such Console.

### CLAIM OF PRIORITY

This application is related to provisional application Serial No. 60/203,811 filed on May 19, 2000 based upon which priority is claimed pursuant to 35 U.S.C. § 119(e).

### TECHNICAL FIELD

This invention relates generally to providing information access via a Wireless Application Protocol (WAP) gateway, and this invention relates specifically to a system for providing the services to users of a WAP gateway.

### BACKGROUND OF THE INVENTION

The demand for wireless services is growing rapidly all around the world. Businesspeople and ordinary consumers lead increasingly mobile lives; they are no longer bound to their home and office computers, but still want to have information at their fingertips whenever they need it. Wireless networks provide people on the move with a medium for easy information access.

The Wireless Application Protocol (WAP) is the de facto world standard for displaying and transmitting information and telephony services on mobile phones and other wireless terminals. The global WAP specification was developed by the industry's top experts as an open standard to implement wireless Internet access. This open standard benefits the whole wireless telecommunication community: carriers, infrastructure vendors, application developers, service providers, and, ultimately, end users. The WAP specification extends existing mobile networking and Internet technologies. It is bearer and device independent, and thus helps foster interoperability.

The WAP programming model is largely based on the WWW programming model with clients and servers. Existing standards have been used as a starting point for WAP technology whenever possible. They have been optimized and extended to provide the best functionality in a wireless environment.

The basic WAP model consists of a client (a WAE user agent, also called a WAP terminal), a gateway, and an origin or content server. A request is sent by an end user through a WAP terminal to a content server on the Internet or in a network. The WAP terminal transmits the request, a standard HTTP request in encoded format, to the gateway. The gateway decodes and processes the request and sends it on to the appropriate content server. The response from the content server is sent back to the gateway over HTTP. The gateway encodes the response and transmits it to the WAP terminal.

The WAP model defines a set of standard components for communication between WAP terminals and content servers.

Standard URL names are used to identify WAP content in a network.

Content is identified by a specific type consistent with WWW typing in order to enable correct processing in the WAP terminal.

Standard content formats based on WWW technology are used.

Standard communications protocols are used to transmit requests from WAP terminals to content servers.

The client device in the WAP programming model is a WAP terminal: a mobile phone or other wireless device used by the end user to request and receive information. A microbrowser in the WAP terminal controls the user interface analogously to a standard Web browser. WAP terminals typically accept data in WML and WMLScript formats. Different types of terminals may also accept bitmaps and other content types.

A WAP gateway communicates with content servers by using the standard HTTP 1.1 protocol. The gateway's location between the WAP terminal and the content server can be compared to that of a standard WWW proxy server. However, a gateway differs from a proxy in that it receives requests from end users as if it were the actual content server for the requested data. The gateway is usually transparent to the end user. The gateway functionality can be added to content servers or placed in a dedicated gateway machine, as in FIG. 1.

The gateway performs most tasks related to WAP use, which minimizes the demand for processing power in the WAP terminal. The use of a gateway allows content and applications to be hosted on standard WWW servers and developed with WWW technologies.

The gateway translates requests from the WAP protocol stack to WWW protocols. It also provides functionality for encoding and decoding data transferred from and to the WAP terminal. WML content from the Internet needs to be encoded in order to minimize the size and number of packets sent to the WAP terminal.

Servers in the WAP model are standard WWW servers that provide WAP content. Content servers can be located on the Internet or in a local network. The content can be anything: stock quotes, weather reports, news headlines, banking services . . . . There are no restrictions to the format of data provided by content servers, but the capabilities of the receiving WAP terminal determines which formats are accepted.

The WAP architecture provides a scalable and extensible environment for further development of applications and devices. The WAP specification defines a lightweight protocol stack that can operate on high-latency, low-bandwidth wireless networks. The stack is located in the gateway and designed so that a variety of networks can run WAP applications. The WAP architecture consists of various layers. External services and applications can use the features provided by different layers through a set of defined interfaces.

WAE is a general application environment based on a combination of WWW and mobile telephony technologies. It provides an interoperable environment for building applications and services that can function in a variety of wireless networks. WAE includes a microbrowser environment for use in WAP terminals.

The session layer is based on modified binary-encoded HTTP 1.1. It provides the application layer with a consistent interface for two modes of session services: connection-oriented and connectionless.

The connection-oriented mode operates above the WTP layer. It provides acknowledgements for request-reply transactions and more reliable service, but uses more bandwidth and processing power in WAP terminals. Connectionless mode operates above WDP. It does not provide acknowledgements, but enables the use of WAP even in narrowband networks and WAP terminals with limited processing power.

Most connections between the WAP terminal and the gateway use WSP regardless of the protocol of the content server from which data is requested. The URL used to request data specifies the protocol used by the content server. Thus, the end user does not need to know what protocol is used in intervening connections.

The transaction layer provides a lightweight, transaction-oriented protocol suitable for implementation in wireless networks. WTP can be compared to traditional TCP in terms of function. However, WTP reduces the amount of information that needs to be transmitted for each request-response transaction, and is thus optimized for wireless use. WTP provides reliability in connections by way of acknowledgements and retransmissions.

The WTLS security protocol is based on the industry standard TLS protocol. WTLS has been optimized for use over narrow-band communication channels and provides features such as data integrity, privacy, authentication, and denial-of-service protection. Most WAP terminals can enable or disable WTLS features depending on the security requirements and the underlying network. The security layer is thus optional in the WAP architecture, but may be used for services such as banking and e-commerce.

The transport layer protocol operates transparently above the bearer services and is adapted to specific features of the underlying bearer. The transport layer provides a common interface for the upper layer protocols (security, transaction, session, and application), which are thus able to function independently of the bearer network.

WAP is designed to operate over different bearer networks. The network layer in the protocol stack supports these bearers. Different bearers offer different levels of service, which the WAP protocols are designed to compensate.

The WAP specification includes the Wireless Markup Language (WML). WML is a tag-based document language that conforms to XML standards and is designed especially for use within the limited computing environment of mobile terminal devices.

From the WAP gateway, all WML content on Web servers is accessed with standard HTTP 1.1 requests. WML documents are divided into units of user interaction called cards and decks. A deck is defined as the entire WML document retrieved (e.g. “Today's news stories”), and a card is the amount of data displayed at once on the WAP terminal (e.g. “First story”, “Second story”). Using cards and decks makes browsing the content faster, as the data does not have to be retrieved from the content server every time the user needs it. The WAP content can be browsed analogously to Web pages: the user can navigate back and forth between cards from one or several decks.

WML provides a variety of features, such as the following:

Content authors can specify text and images presented to the end user.

Layout and presentation on WAP terminals are specified in general terms, which allows independence for device developers.

Support is provided for elements to solicit user input, such as text entries (e.g. passwords) and option selection.

WML allows several navigation mechanisms using URLs and enables international support for different character sets.

WML includes a variety of technologies to optimize communication on narrow-band devices.

WML enables state and context management.

WMLScript is a lightweight, procedural scripting language. It is loosely based on a subset of the industry standard JavaScript™ language, but adapted for optimum use in the narrow-band environment of wireless terminals. WMLScript supports several basic data types and attempts to convert automatically between different types when necessary. WMLScript also supports several categories of operations and functions and defines several standard libraries.

WMLScript is fully integrated with the WML browser in the WAP terminal and enhances the standard browsing and presentation facilities of WML. It enables the WAP terminal to interact with the user in a more intelligent way, for example to check the validity of user input before it is sent to the content server.

Due to the limited processing power of WAP terminals and the requirements of over-the-air transmission, data needs to be sent from the gateway to the WAP terminal in as compact a format as possible. The gateway contains compilers that convert WML and WMLScript into their binary encoded counterparts. Each WML deck is converted into its binary format, WMLC; WMLScript is compiled into low-level bytecode. The compiled data is then sent to the WAP terminal for interpretation and execution.

Many applications on the Internet, such as banking services, require a secure connection between the WAP terminal and the content server. The WAP specification defines a security layer, WTLS, which is used with WAP transport protocols. WAP can provide end-to-end security for connections where the terminal and content server communicate directly using WAP protocols.

The WAP environment supports HTTP 1.1 basic authentication where an end user can be authenticated on the basis of a username and a password. WAP can also use the authentication methods of the underlying bearer network.

Using the WAP environment, a service provider must administer to its users in a consistent, uniform manner, providing adequate security measures to all users, permitting and/or preventing access to certain classes of service, and giving users the confidence necessary to enable them to use the service without worries related to cyberspace.

Thus, there is a need in the art for a system for providing information to consumers over a WAP enabled gateway.

### SUMMARY OF THE INVENTION

The present invention solves significant problems in the art by providing a computer-implemented system for administering access to Wireless Application Protocol (WAP)-based services.

In a preferred embodiment of the invention, what is provided is a system for providing information over a Wireless Application Protocol Gateway, comprising at least one Access Point; a Core; a Knowledge Base; an Administrative Console; a Statistics Module; and, at least one Content Server.

In an alternate embodiment of the invention, what is provided is a system for providing information over a wireless application protocol gateway in a Cellular Digital Packet Data network, with static Internet Protocol addressing, comprising: a Core; a Knowledge Base; an Administrative Console; a Statistics Module; and, at least one Content Server.

In another alternate embodiment of the invention, what is provided is a system for providing information over a Wireless Application Protocol Gateway, comprising at least one Access Point, wherein the Access Point enables consumers to connect to the gateway and further is utilized in a Circuit Switched Data network, whereby incoming traffic from the network is directed through a dialup server over User Datagram Protocol; a Core, wherein the Core transmits requests from consumers to the Content Servers on a global network of computers, and data from the Content Servers back to the consumers, the Core comprised of content adapters, session/transaction handling modules, WAP Stack modules, and Wireless Datagram Protocol modules; a Knowledge Base, wherein the Knowledge Base is a database that contains service definitions and individual user data, said Knowledge Base further saving details of all sessions and transactions in logs that are used to create billing data; an Administrative Console, wherein said Administrative Console is a web-based user interface for administration and management of the Gateway; a Statistics Module, wherein the Statistics Module is in operative communication with said Core via the Administrative Console, the Statistics Module consisting of various counters that monitor different values related to the system status, such as the number of sessions and transactions, memory usage, and system uptime; and, at least one Content Server, wherein the Content Server can be located on the Internet or in a local network.

In another alternate embodiment of the invention, what is provided is a system for providing information over a wireless application protocol gateway in a Cellular Digital Packet Data network, with static Internet Protocol addressing, comprising a Core, wherein the Core transmits requests from consumers to the Content Servers on a global network of computers, and data from the Content Servers back to the consumers, the Core comprised of content adapters, session/transaction handling modules, WAP Stack modules, and Wireless Datagram Protocol modules; a Knowledge Base, wherein the Knowledge Base is a database that contains service definitions and individual user data, said Knowledge Base further saving details of all sessions and transactions in logs that are used to create billing data; an Administrative Console, wherein the Administrative Console is a web-based user interface for administration and management of the Gateway; a Statistics Module, wherein the Statistics Module is in operative communication with the Core via the Administrative Console, the Statistics Module consisting of various counters that monitor different values related to the system status, such as the number of sessions and transactions, memory usage, and system uptime; and, at least one Content Server, wherein the Content Server can be located on the Internet or in a local network.

In another alternate embodiment of the invention, what is provided is a system for providing information over a Wireless Application Protocol Gateway, comprising a Core; an Administrative Console; a Statistics Module; and, at least one Content Server.

Thus, it is an object of the present invention to provide a system for providing information to consumers over a WAP enabled gateway.

This and other objects, features, and advantages of the present invention will become apparent upon reading the following specification when taken in conjunction with the accompanying drawings

### BRIEF DESCRIPTION OF THE DRAWINGS

FIG. 1 is a flow chart illustrating the Administration Console of the preferred embodiment of the present invention.

FIG. 2 is a continuation of the flow chart of FIG. 1.

FIG. 3 is an illustration of a login page utilized in the Administration Console of the preferred embodiment of the present invention.

FIG. 4 is an illustration of a device list utilized in the Administration Console of the preferred embodiment of the present invention.

FIG. 5 is an illustration of a monitor module status page utilized in the Administration Console of the preferred embodiment of the present invention.

FIG. 6 is an illustration of an events page utilized in the Administration Console of the preferred embodiment of the present invention.

FIG. 7 is an illustration of a counter page utilized in the Administration Console of the preferred embodiment of the present invention.

FIG. 8 is an illustration of a gateway configuration editor page utilized in the Administration Console of the preferred embodiment of the present invention.

FIG. 9 is an illustration of a user page utilized to search for existing users or add new users in the Administration Console of the preferred embodiment of the present invention.

FIG. 10 is an illustration of a page utilized to add new users in the Administration Console of the preferred embodiment of the present invention.

FIG. 11 is an illustration of a page utilized to add new bearer addresses in the Administration Console of the preferred embodiment of the present invention.

FIG. 12 is an illustration of a page utilized to set service subscriptions in the Administration Console of the preferred embodiment of the present invention.

FIG. 13 is an illustration of a new service subscription page utilized in the Administration Console of the preferred embodiment of the present invention.

FIG. 14 is an illustration of a page utilized to view and edit service subscriptions in the Administration Console of the preferred embodiment of the present invention.

FIG. 15 is an illustration of a login page utilized to set new service subscription billing parameters in the Administration Console of the preferred embodiment of the present invention.

FIG. 16 is an illustration of a page utilized to set new service subscription billing options in the Administration Console of the preferred embodiment of the present invention.

FIG. 17 is an illustration of a page utilized to detail a user's service subscription billing parameters in the Administration Console of the preferred embodiment of the present invention.

FIG. 18 is an illustration of a page utilized to set new service subscription billing parameters in the Administration Console of the preferred embodiment of the present invention.

FIG. 19 is an illustration of a page utilized to add users to groups in the Administration Console of the preferred embodiment of the present invention.

FIG. 20 is an illustration of a user groups page utilized to view group membership in the Administration Console of the preferred embodiment of the present invention.

FIG. 21 is an illustration of a user groups page utilized to edit group membership data in the Administration Console of the preferred embodiment of the present invention.

FIG. 22 is an illustration of a group's members page utilized in the Administration Console of the preferred embodiment of the present invention.

FIG. 23 is an illustration of a user's or a group's user alias page utilized in the Administration Console of the preferred embodiment of the present invention.

FIG. 24 is an illustration of a services page utilized in the Administration Console of the preferred embodiment of the present invention.

FIG. 25 is an illustration of a new service page utilized in the Administration Console of the preferred embodiment of the present invention.

FIG. 26 is an illustration of a service billing options page utilized in the Administration Console of the preferred embodiment of the present invention.

FIG. 27 is an illustration of a customized service billing options page utilized in the Administration Console of the preferred embodiment of the present invention.

FIG. 28 is an illustration of a service billing options prices page without any price categories defined, as utilized in the Administration Console of the preferred embodiment of the present invention.

FIG. 29 is an illustration of a service billing options prices page with one price category defined, as utilized in the Administration Console of the preferred embodiment of the present invention.

FIG. 30 is an illustration of a new service price page for editing a price category, as utilized in the Administration Console of the preferred embodiment of the present invention.

FIG. 31 is an illustration of a service address page utilized in the Administration Console of the preferred embodiment of the present invention.

FIG. 32 is an illustration of a billing models page utilized in the Administration Console of the preferred embodiment of the present invention.

FIG. 33 is an illustration of a global prices page utilized in the Administration Console of the preferred embodiment of the present invention.

FIG. 34 is an illustration of a new price page utilized in the Administration Console of the preferred embodiment of the present invention.

FIG. 35 is an illustration of the prior art basic Wireless Application Protocol (WAP) programming model.

FIG. 36 is an illustration of the prior art WAP architecture, which consists of various layers.

FIG. 37 is an illustration of the present invention's WAP Gateway architecture.

### DETAILED DESCRIPTION OF THE PREFERRED EMBODIMENT

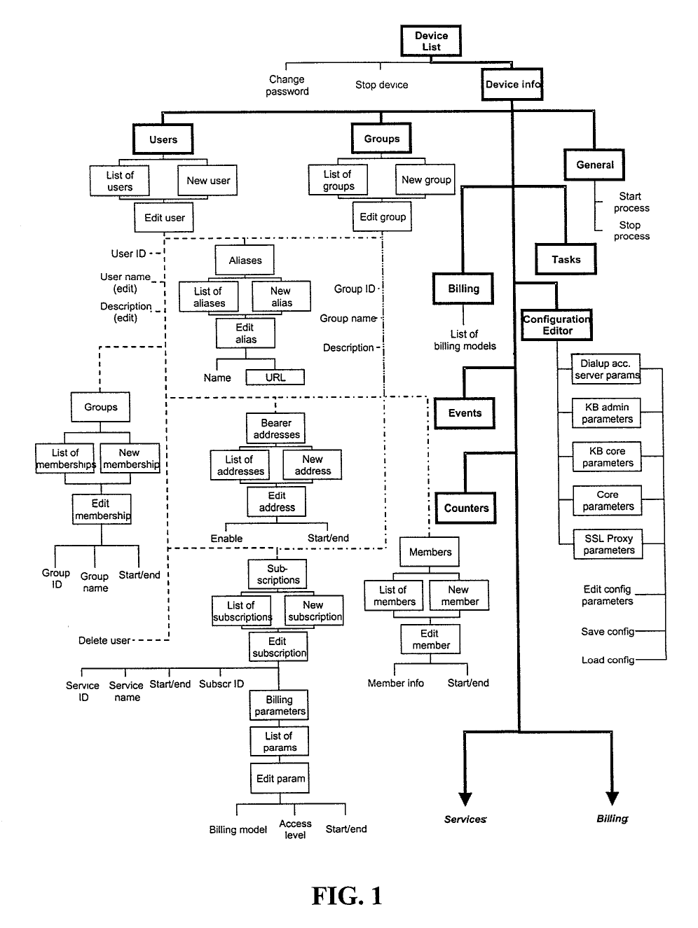

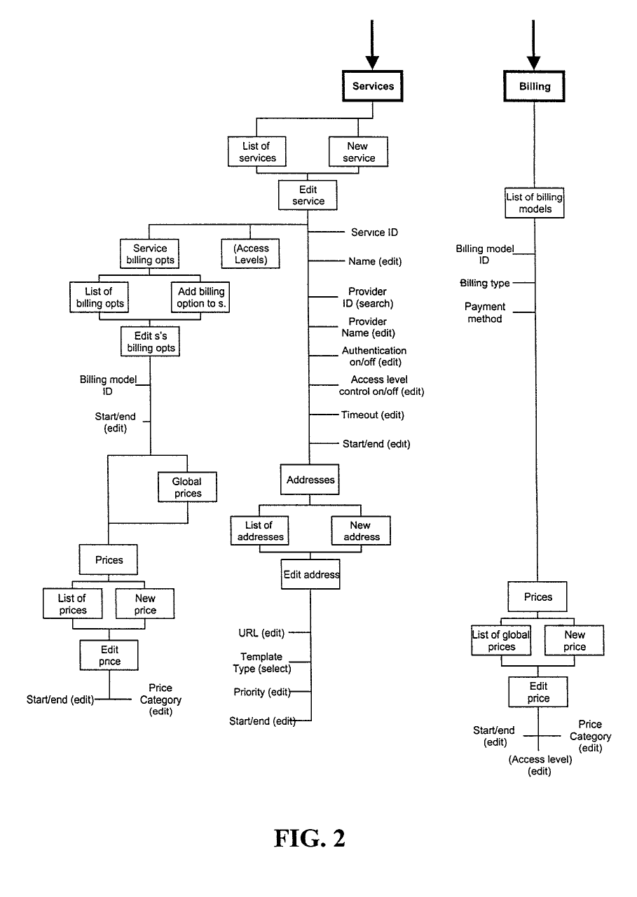

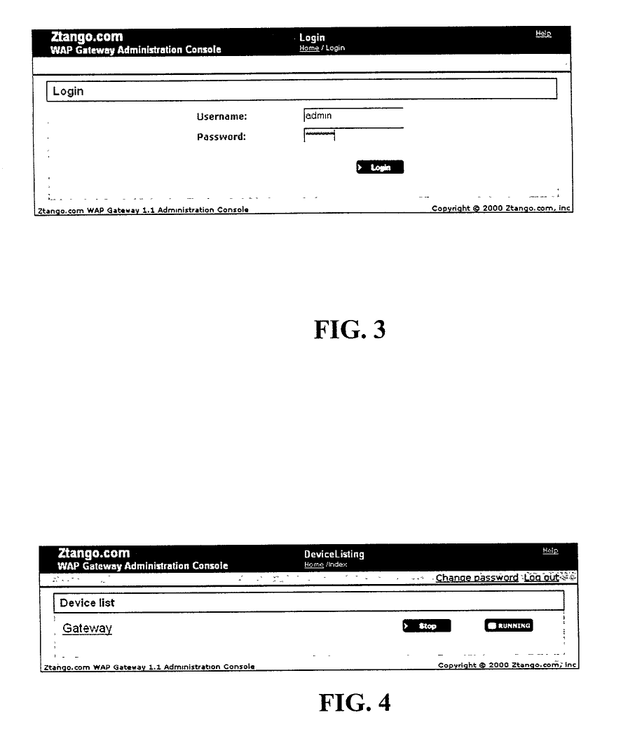

Turning next to the figures, FIGS. 1-2 are a flow chart which illustrates how the Web-based Administration Console tool is organized. The console is Web-based and requires a browser, such as Microsoft Internet Explorer or Netscape Navigator, to operate. To start the administration console, the browser is opened and the administrator of the gateway connects to the desired gateway by using the gateway's hostname or IP number, bringing up the login page (FIG. 3). The user then supplies a username and password and clicks “login”, after which the gateway administration console device list page opens (FIG. 4). The first time the administrator logs in to the administration console, he is encouraged to change the password to protect the gateway installation. On the device list page (FIG. 4), the administrator selects “change password”, enters his username and a new password, re-enters the new password for verification purposes, and clicks “update”.

The administrator can move around in the Administration Console by clicking on links. In the Console the links take the administrator to different parts of the Administration Console, or even to various products, different Gateway devices, or associated services. The administrator can return to a higher-level page (for example, from a specific user's pages to the main Users page by clicking the Console's Back button. The administrator can also use the browser's Back and Forward buttons to navigate to pages recently visited.

The first page seen is the Device List page. By clicking on the identifier of a device, access is provided to that device's General page. To get back to the Device List page, the user simply clicks “home” at the top of the page. To log out of the Administration Console, the user simply clicks “home” and “log out”. The Administration Console is mainly used for entering information. On some pages, the administrator is provided the option of browsing for the information if it has already been entered elsewhere in the Knowledge Base.

To use the browse window, the user clicks “browse” on any page where it appears. The Browse window opens. The user then enters a search criterion in one of the text boxes provided, clicks “search”, and is provided a list of search results. To add an entry in the list (i.e. a name, an ID, or a bearer address) to the text box on the page, the user simply clicks the entry in the Browse window list.

The administration console also provides help to users. Gateway user documentation is available onscreen through a link in the Administration Console, simply by clicking “help” on the administration console.

The Administration Console tool permits users to perform specific tasks, such as shutting down the Gateway for physical maintenance operations. To shut down the gateway, the user clicks “stop” next to the device to be shut down, on the Device List page (FIG. 4). When the system that the Gateway is installed on is restarted, the Gateway starts automatically.

If one module of the Gateway experiences problems, the entire system need not be shut down. The various modules can be restarted or rebooted separately. The modules which can be started and stopped are as follows:

OSModule:Monitors the operating system of a Gateway machine

Dialup accounting server: The address resolver

Core: The central part of the Gateway that handles sessions and transactions

Knowledge base core: The database section of the Knowledge Base

Statistics: The information gathering process

SSL proxy: The module that handles secure sessions

Knowledge base admin: The administration interface of the Knowledge Base

The Gateway of the present invention allows users to monitor the status of the gateway installation and the various modules that it is running. The user can use the same Administration Console to monitor several devices. The Device List page shows the overall status of each Gateway device. The status is displayed with a colored icon on the right side of the page, a green “running” status or a red “fail” status. If a device is in Fail mode, a number is displayed to the right of the icon. This number is a reference meant for support staff.

The General page shows the status of the current device's modules. Only modules that can be stopped and restarted without harming the Gateway installation are displayed:

OSModule

Dialup accounting server

Core

Knowledge base core

Statistics

SSL proxy

Knowledge base admin

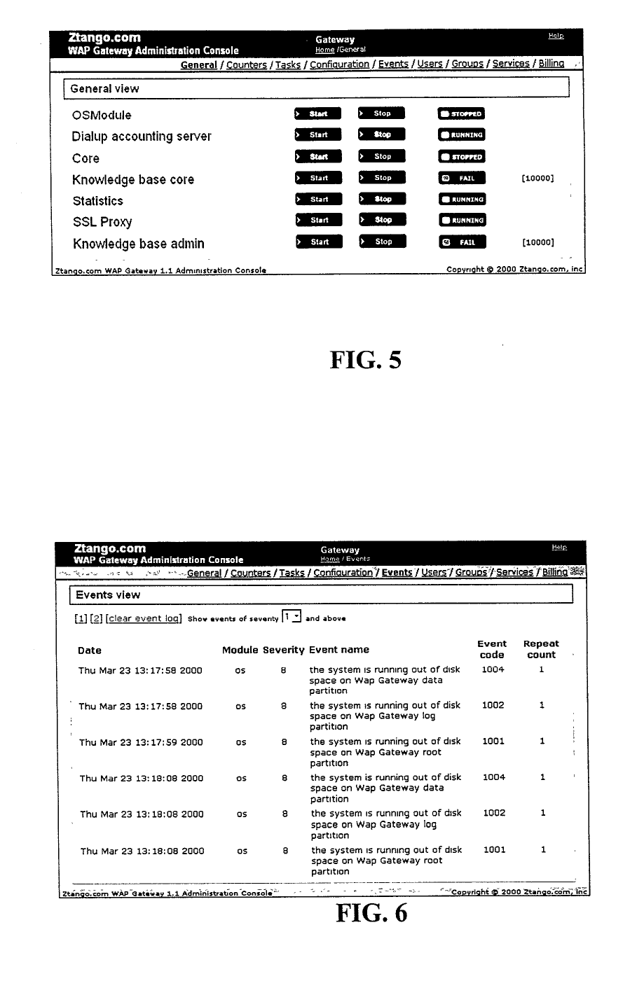

This setup is illustrated in FIG. 5. The status of each module is shown with a colored icon, either green “running”, yellow “stopped”, or red “fail”. If a module is in Fail mode, a reference number is displayed next to the icon. If the user must call support, the reference assists the support provider with technical support. If any module that is running has errors, an alert is displayed on the Events page of the Administration Console.

To find out what events have taken place in the Gateway installation, the Events page, shown in FIG. 6, is used. This page displays a chronological list of all Gateway events. The console can display up to 500 events.

The event information is divided into six columns:

Date: When the event occurred

Module: The Gateway module where the event occurred

Severity: How serious and potentially harmful the occurrence of the event is on a scale of 1 (least serious: debug) to 9 (most serious: fatal)

Event name: A verbal description of the event

Event code: A code number identifying the event

Repeat count: How many times the event occurred

The events are divided into severity classes as follows:

1—for information only—no actions are needed

8—alert—Gateway is operating but actions are needed as soon as possible

9—alert—Gateway is not operating, immediate actions are needed

The event code, severity and description are displayed on the Events page of the Administration Console. Severity class 1 events are notifications about the basic functions the Gateway performs that are displayed for information only—no actions are needed. Severity class 1 events include the following:

GENERAL.gateway starting: This message appears on the Events page every time the Gateway Core on the General page of the Administration Console is started.

GENERAL.gateway shutting down: This message appears on the Events page every time the Gateway Core is stopped.

GENERAL.gateway reconfiguring: This message is displayed when the values of the parameters on the Configuration page of the Administration Console are changed.

Class 8 events are alerts generated in situations when the Gateway is still operating but is recommended that efforts be made to try to fix the problem as soon as possible to ensure good performance. Class 8 events include the following:

CMODE.sessionlimit reached: This alert is displayed when the CMODE.numOfSessions counter reaches the maximum value which was set. No new sessions can be initiated before some of the ongoing ones have finished. The Gateway handles the ongoing sessions normally. If the session limit is often reached and there are a lot of refused connections, it is advisable to fix the problem to improve the end user experience. The only way to fix the problem is to set a higher value for the maxCmodeSessions parameter on the Configuration page.

CMODE.transactionlimit reached: This alert is displayed when the CMODE.numOfTransactions counter reaches the maximum value which was set. No new transactions can be executed before some of the ongoing ones have finished. The only way to fix the problem is to set a higher value for the maxCmodeTransactions parameter on the Configuration page.

CLESS.transactionlimit reached: This alert is displayed when the CLESS.numOfTransactions counter reaches the maximum value that was set. No new transactions can be executed before some of the ongoing ones have finished. The only way to fix the problem is to increase the maxClessTransactions value on the Configuration page.

GENERAL.content adapter busy: This alert is generated when a content adapter cannot handle any further requests. The Gateway includes several instances of the HTTP adapter. The problem may be fixed by increasing the number of HTTP instances. Another possible solution is to adjust the adapter configuration. Redefine the values of the set descriptor, fetch_threads, and max_descriptor parameters.

GENERAL.error creating content adapter message: This alert appears on the Events page if the Core cannot create a content adapter message because there are no available shared memory blocks. This might be the case if the Gateway gets overloaded. To fix the problem, try to increase the number of shared memory blocks on the Configuration Editor page.

GENERAL.error contacting content adapter: This alert is displayed if sending a request message to a content adapter has either timed out or if the adapter has failed. It is recommended to restart the Gateway as soon as it can be shut down causing end users a minimum amount of inconvenience. To fix the problem, on the General page of the Administration Console, stop the Core module and restart the module.

Severity class 9 events are fatal errors. Because the Gateway Core is not functioning, immediate actions are needed. The class 9 errors include the following:

GENERAL.error initializing KB-connection: This alert appears on the Events page if the address specified in the kbAddress field on the Configuration page is invalid or the port is busy. Check that the address is correct and given in the correct format. Check that the same address is given in the corekb field as well.

GENERAL.error initializing shared memory

GENERAL.error initializing content adapter interface

GENERAL.error contacting KB (request mapping): This alert is displayed if an error has occurred when the Gateway Core tried and failed to perform an operation related to the Knowledge Base. It indicates that mapping a request to a service has failed.

GENERAL.error contacting KB (cless transaction log): This alert is displayed if an error has occurred when the Gateway Core tried to perform a Knowledge Base operation. It indicates that connectionless mode transaction logging has failed.

GENERAL.error contacting KB (cmode transaction log): This alert is displayed if an error has occurred when the Gateway Core tried to perform a Knowledge Base operation. It indicates that connection-oriented mode transaction logging has failed.

GENERAL.error contacting KB (cmode session log): This alert is displayed if an error has occurred when the Gateway Core tried to perform a Knowledge Base operation. It indicates that connection-oriented mode session logging has failed.

GENERAL.content adapter not found: This alert appears if the Core cannot find a content adapter to direct a request to. Either there are no operating content adapters or the adapter configuration is invalid.

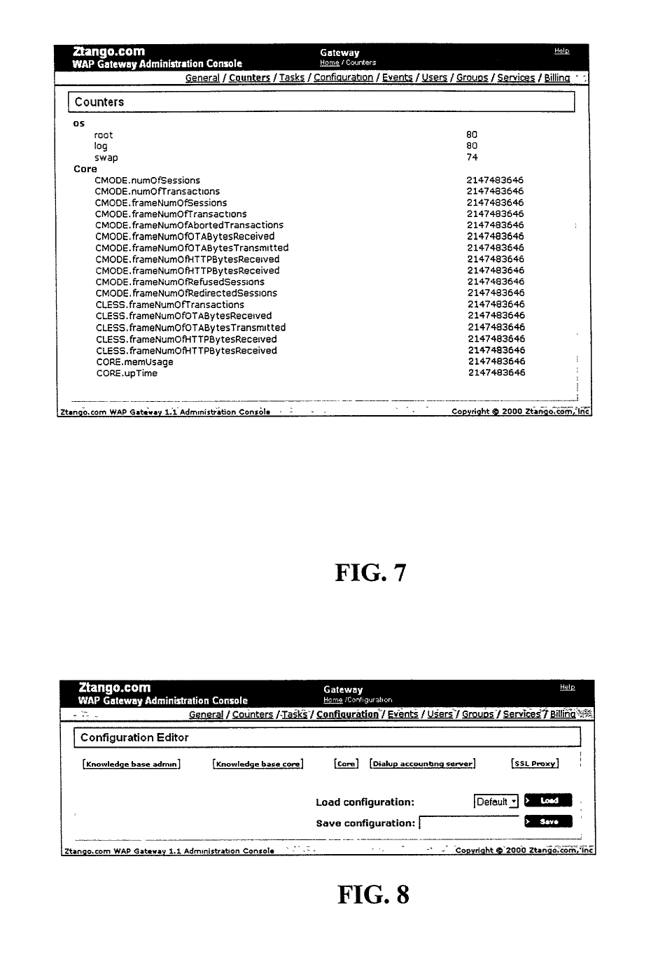

The Counters page, shown at FIG. 7, displays various general statistics for the modules of the Gateway installation. They reflect the amount and type of traffic taking place at each interface. When installing the Gateway, the disks are divided into partitions. Specific counters monitor the capacity of each partition. If a counter reaches a critical value, an alert is displayed on the Events page. Nonetheless, the Gateway remains completely operational until the partition is fall. The various counter alerts are as follows:

the system is running out of disk space on Wap Gateway root partition

This alert is generated if the root counter reaches 80%.

the system is running out of disk space on Wap Gateway log partition

This alert is generated if the log counter reaches 80%. the system is running out of swap space

This alert is generated if the swap counter reaches 80%.

the system is running out of disk space on Wap Gateway data partition

This alert is generated if the data counter reaches 80%.

The number of the events displayed on the Events page is limited. When the 500th event is generated, an alert will appear instead. No new events are displayed after that point. In case the following alert (with code 9000 or code 9001) appears, immediately clear the event log on the Events page of the Administration Console.

Message queue is full (any further messages will be discarded)

This event is displayed when there are 499 events and a new event is to be generated.

The administration console collects numerical information and advises as to how to use the information to improve performance. The Gateway collects information from the actions at the system interfaces. These statistics consist of values that the counters return. This numerical information can be used to monitor system status and as an information source for customized statistics applications. In addition to a general overview on the system status, the counters also provide valuable information during alert situations. Based on this information, improved performance and customer service is available. The Gateway counters indicate two types of values: operating system data and Core data. These values indicate the situation either at the present moment or during the latest time frame. The time frame is defined on the Configuration page of the Administration Console. The parameter is called frame period.

The Administration Console also includes a Gateway Configuration Editor, seen in FIG. 8. The Configuration Editor is used to view and change Gateway configuration parameters. During the installation, all parameters are given default values that depend on the hardware configuration and operational environment. When certain parameters are changed, the corresponding module in the Gateway needs to be restarted, which causes a short break in service. It is recommended to change these parameters when Gateway traffic is at a minimum. However, most of the parameters that require restarting modules rarely need adjusting after the initial installation and configuration.

Other parameters do not require restarting modules, and changes to them can be applied directly. The changed parameters are applied immediately and the settings are preserved even when the Gateway is restarted. All parameters can be set through the Configuration Editor of the Administration Console. Various sets of configuration parameters can also be saved and loaded when necessary.

Parameters under the Knowledge base admin section deal with the interface between the Knowledge Base and the Administration Console, and include as follows:

Knowledge Base—Core parameters

Parameters under the Knowledge base core section deal with the interface between the Knowledge Base and the Core. (The Knowledge Base is an optional part of the WAP Gateway and is not included in all installations.)

Port

The port parameter defines the port used by the Core to communicate with the Knowledge Base. The parameter value has the format protocol:machine_name:port_number. The machine name is the machine where the Gateway is installed (localhost if the Knowledge Base and the Gateway are on the same machine). This parameter should be set to the same value as the kbAddress parameter.

When this parameter has been changed, the Knowledge base core module has to be restarted for the change to take effect.

Threads

The threads parameter defines the number of threads (positive integer), i.e. the number of transactions that can be simultaneously processed by the Knowledge Base. This parameter can have a value between 1 and 128.

When this parameter has been changed, the Knowledge base core module has to be restarted for the change to take effect.

Core parameters

Parameters under the Core section affect the functioning of the WAP Gateway Core. They include parameters for connection-oriented mode and connectionless mode, content adapters, and error messages.

Content adapters

Content adapters in the Gateway retrieve data requested by users from various content servers that support WAP retrieval. Multiple instances of the HTTP adapter can be set to run simultaneously. The content adapter interface in the Gateway allows different types of content adapters, such as RPC adapters, to be added in the future.

There are several parameters that affect content adapters and that can be set through the Administration Console. The content adapter 0 subheading indicates the content adapter type (0 for HTTP).

Path

The path parameter defines the location of the content adapter.

When this parameter has been changed, the Core module has to be restarted for the change to take effect.

Amount

The amount parameter defines how many instances of the HTTP adapter are running simultaneously.

No modules need to be restarted for changes to this parameter to take effect; clicking Apply at the bottom of the page is sufficient.

Scheduler

The scheduler parameter defines the basis for selecting a content adapter to process a request, i.e. the order in which content adapters process requests. HTTP adapters can have the values “roundrobin” or “url”. The value “roundrobin” means that every new request is sent to the next HTTP adapter (the order of the HTTP adapters is defined internally). The value “url” means that a request for data from an URL is sent to the HTTP adapter that has previously retrieved data from that particular URL. This speeds up the retrieval process.

When this parameter has been changed, the Core module has to be restarted for the change to take effect.

Shared memory

These parameters affect the shared memory used for transmitting requests through the Gateway to content adapters.

Name

The name parameter defines the shared memory path. The path name must start with a slash (/) and may have a maximum of 14 characters.

When this parameter has been changed, the Core module has to be restarted for the change to take effect.

Block size

The block size parameter defines the size (number of bytes) of each block.

When this parameter has been changed, the Core module has to be restarted for the change to take effect.

Blocks

The blocks parameter defines the total number of blocks (positive integer) used to transmit requests. The number of blocks is equal to the total number of requests that can be pending on all content adapters.

No modules need to be restarted for changes to this parameter to take effect; clicking Apply at the bottom of the page is sufficient.

HTTP adapter default

These parameters are related to the functions and settings of HTTP adapters.

Number of threads per HTTP adapter

The fetch threads parameter defines the number of threads per HTTP adapter, i.e. the number of requests that can be simultaneously processed in each HTTP adapter. The value of this parameter is limited by the value of the set descriptor parameter; the number of descriptors in a process limits the number of simultaneous requests and thus the number of threads.

No modules need to be restarted for changes to this parameter to take effect; clicking Apply at the bottom of the page is sufficient.

Maximum number of descriptors

The max descriptor parameter defines the maximum number (positive integer) of descriptors used for HTTP requests. It is recommended to set this value lower than the default number of descriptors defined in the operating system (see set descriptor) in order to have descriptors free for other functions.

When this parameter has been changed, the Core module has to be restarted for the change to take effect.

Total number of descriptors

The set descriptor parameter defines the total number (positive integer) of descriptors used for all content processing. Each HTTP request needs one descriptor, and descriptors are also needed for reading and writing files. The value of the set descriptor parameter is limited by the maximum number of descriptors allowed in the operating system.

No modules need to be restarted for changes to this parameter to take effect; clicking Apply at the bottom of the page is sufficient.

HTTP proxy

The http proxy parameter defines the IP address or hostname of the HTTP proxy used by the content adapter to retrieve data.

No modules need to be restarted for changes to this parameter to take effect; clicking Apply at the bottom of the page is sufficient.

HTTP proxy port

The http proxy port parameter defines the port of the HTTP proxy.

No modules need to be restarted for changes to this parameter to take effect; clicking Apply at the bottom of the page is sufficient.

SSL proxy

The ssl proxy parameter defines the IP address or hostname (usually localhost) of the SSL proxy used by the Gateway. (SSL is an optional feature.)

No modules need to be restarted for changes to this parameter to take effect; clicking Apply at the bottom of the page is sufficient.

SSL proxy port

The ssl proxy port parameter defines the port of the SSL proxy.

No modules need to be restarted for changes to this parameter to take effect; clicking Apply at the bottom of the page is sufficient.

Persistent connections

When data is retrieved from an HTTP server, the connection can be closed immediately or it can persist, which means that reretrieving data from the same source is faster. HTTP 1.1 supports persistent connections by default, HTTP 1.0 does not. When an HTTP proxy is used, all retrievals are from the proxy.

The persistent connections parameter enables (1) or disables (0) the use of persistent connections with HTTP 1.1 servers. The period of time that the connection persists depends on each server's particular settings and cannot be defined in the Gateway.

No modules need to be restarted for changes to this parameter to take effect; clicking Apply at the bottom of the page is sufficient.

Connect timeout

If the HTTP adapter cannot connect with the content server within a certain period of time, the connection attempt is aborted and an error message is returned to the Core and the user's WAP terminal. The connect timeout parameter defines the time (number of seconds) after which the connection attempt is aborted.

No modules need to be restarted for changes to this parameter to take effect; clicking Apply at the bottom of the page is sufficient.

Read timeout

After a connection is made to the content server, the HTTP adapter reads data from the server. The connection is closed if no data is returned from the content server. The read timeout parameter defines the time (number of seconds) after which the connection is closed.

No modules need to be restarted for changes to this parameter to take effect; clicking Apply at the bottom of the page is sufficient.

Log parameters

The system log parameters (log threshold, log size limit, log categories, and log flush interval) for HTTP adapters have the same functions as those for the Core. However, the parameter values can be different.

No modules need to be restarted for changes to these parameters to take effect; clicking Apply at the bottom of the page is sufficient.

General

General Core parameters are valid for both connection-oriented and connectionless mode. These parameters are related to internal logs generated by the system, requests sent to content adapters, counters that indicate system status, connections between the Core and the Knowledge Base, address resolution, and SMS.

Log directory

System logs are text files that store information to be used by support personnel in possible error situations. In normal circumstances, the system administrator does not need to view the system logs.

The log directory parameter defines the location of the directory where system logs are saved. The directory path is /wapgw/gateway/log.

When this parameter has been changed, the Core module has to be restarted for the change to take effect.

Log threshold

The log threshold parameter defines the maximum number (positive integer) of system log files that are stored. The number depends on the amount of disk space available and the volume of traffic through the Gateway. Old logs that exceed the threshold limit are deleted.

No modules need to be restarted for changes to this parameter to take effect; clicking Apply at the bottom of the page is sufficient.

Log size limit

The log size limit parameter defines the size (number of bytes) after which a new system log is started. Recommended values depend on the amount of disk space available and the volume of traffic through the Gateway.

No modules need to be restarted for changes to this parameter to take effect; clicking Apply at the bottom of the page is sufficient.

Log categories

The log categories parameter defines the category of information that is written to the system logs. The Gateway provides the following log category levels: All, None, Debug, Informative, Notice, Warning, Alert, Error, and Fatal.

In the All category, all levels of system information are logged. In the None category, nothing is logged. This option can be used for testing the performance of the Gateway. The Debug category contains all the necessary information for possible problem situations. The categories from Informative to Fatal range from less serious to more serious in content.

Successive categories are not inclusive, but they can be combined, for example “Informative+Notice+Warning” or “All−Debug”.

No modules need to be restarted for changes to this parameter to take effect; clicking Apply at the bottom of the page is sufficient.

Log flush interval

The log flush interval parameter defines the interval (number of seconds) at which log information generated by the system is flushed from buffers to disk. For maximum efficiency, the value −1 can be used, which means that log information is flushed only when the buffers are full. However, this also means that important information might not be logged in time if a problem situation occurs.

No modules need to be restarted for changes to this parameter to take effect; clicking Apply at the bottom of the page is sufficient.

Thread pool sizes

When a request from a WAP terminal comes in, it is given to a thread for processing until it is sent to a content adapter. There are two thread pools, the request and response pools. The request pool processes requests from WAP terminals through the Core to the content adapter; the response pool processes returning messages from the content adapter through the Core to the WAP terminal.

The thread pool sizes parameter defines the maximum number (positive integer) of threads in the thread pools. Both thread pools are the same size.

No modules need to be restarted for changes to this parameter to take effect; clicking Apply at the bottom of the page is sufficient.

Content adapter timeout for sending requests

The ca send timeout parameter defines the time (number of seconds) after which the attempt to send a request to a content adapter is aborted if the content adapter does not respond.

No modules need to be restarted for changes to this parameter to take effect; clicking Apply at the bottom of the page is sufficient.

Content adapter check period for sending requests

The ca send check period parameter defines the interval (number of seconds) at which the gateway checks whether requests to content adapters have timed out. Error messages are sent to the end users whose requests have timed out.

No modules need to be restarted for changes to this parameter to take effect; clicking Apply at the bottom of the page is sufficient.

Frame period

The frame period parameter defines the length (number of seconds) of a frame. Frames are used in counters that measure various numerical values, such as the number of transactions or bytes received, reached during the frame period.

No modules need to be restarted for changes to this parameter to take effect; clicking Apply at the bottom of the page is sufficient.

Enabling the Knowledge Base

The Knowledge Base is used for various Gateway functions, such as access control, service mapping, and aliasing. The Knowledge Base is usually enabled, but it may be disabled if mapping or aliasing is not needed, or if users cannot be identified due to characteristics of the underlying network.

The kbEnabled parameter enables (1) or disables (0) the Knowledge Base. (The Knowledge Base is not included in all installations.)

No modules need to be restarted for changes to this parameter to take effect; clicking Apply at the bottom of the page is sufficient.

Knowledge Base address

The kbAddress parameter defines the protocol and port used to listen for connections from the Knowledge Base. The parameter value has the format protocol:machine_name:port_number. The machine name is the machine where the Gateway is installed (localhost if the Knowledge Base and the Gateway are on the same machine).

When this parameter has been changed, the Core module has to be restarted for the change to take effect.

Enforcing access control

The enforceAccessControl parameter defines whether the Gateway allows access to services when users cannot be recognized or when a Knowledge Base query fails. This parameter enables (1) or disables (0) enforced access control. When enforced access control is enabled, the Gateway does not allow unrecognized users to access services.

No modules need to be restarted for changes to this parameter to take effect; clicking Apply at the bottom of the page is sufficient.

Enabling the address resolver server

The address resolver is a process in the Core that resolves IP addresses. In version 1.1 of the Gateway, the dialup accounting server functions as the address resolver.

If the bearer network uses bearer addresses in the form of static IP addresses instead of MSISDNs, no address resolution is necessary. The useAddressResolverServer parameter defines whether the address resolver is used. This parameter enables (1) or disables (0) the address resolver.

No modules need to be restarted for changes to this parameter to take effect; clicking Apply at the bottom of the page is sufficient.

Address resolver server address

The addressResolverServerAddress parameter defines the IP address of the address resolver. The parameter value has the format protocol:machine_name:port_number.

When this parameter has been changed, the Core module has to be restarted for the change to take effect.

SMS gateway address

The SMS Gateway Address parameter defines the IP address of the SMS Gateway.

No modules need to be restarted for changes to this parameter to take effect; clicking Apply at the bottom of the page is sufficient.

SMS service number

The SMS Service Number parameter is configured into the end user's WAP terminal. This number identifies the WAP Gateway in the GSM network.

No modules need to be restarted for changes to this parameter to take effect; clicking Apply at the bottom of the page is sufficient.

Connection-oriented mode

These parameters are related to the functions and settings in connection-oriented mode.

Enabling the secure port

The enableSecurePort parameter defines whether the secure port for connection-oriented mode is enabled (1) or disabled (0). The secure port is used for connections over WTLS, if the end user's WAP terminal supports WTLS. (WTLS is an optional feature.)

When this parameter has been changed, the Core module has to be restarted for the change to take effect.

Enabling the unsecure port

The enableUnsecurePort parameter defines whether the unsecure port for connection-oriented mode is enabled (1) or disabled (0).

When this parameter has been changed, the Core module has to be restarted for the change to take effect.

Enabling redirection

Connections to a Gateway can be redirected to another Gateway. Redirection is only valid in connection-oriented mode, and can thus be used for load balancing; all connectionless requests can be handled at one Gateway and all connection-oriented requests can be redirected to another. This increases the maximum number of simultaneous sessions and transactions and improves service to end users.

The redirect parameter enables (1) or disables (0) the redirect function.

No modules need to be restarted for changes to this parameter to take effect; clicking Apply at the bottom of the page is sufficient.

Redirection IP address

The redirectAddress parameter defines the IP address of the Gateway to which requests are redirected.

No modules need to be restarted for changes to this parameter to take effect; clicking Apply at the bottom of the page is sufficient.

Maximum number of connection-oriented sessions

The maxCmodeSessions parameter defines the maximum number (positive integer) of simultaneous sessions in connection-oriented mode. The maximum number can vary according to the capacity of the system.

No modules need to be restarted for changes to this parameter to take effect; clicking Apply at the bottom of the page is sufficient.

Maximum number of connection-oriented transactions

The maxCmodeTransactions parameter defines the maximum number (positive integer) of simultaneous transactions in connection-oriented mode. The maximum number can vary according to the capacity of the system.

No modules need to be restarted for changes to this parameter to take effect; clicking Apply at the bottom of the page is sufficient.

Session timeout

Sessions are normally disconnected with a handshake procedure. When the WAP terminal aborts the session without a proper handshake, the session is still being processed by the Gateway. The sessiontimeout parameter defines the time (number of seconds) after which a session is disconnected, i.e. the connection is closed at the Gateway's end, if there are no new requests or messages coming from the WAP terminal.

The parameter value can be decreased if the maximum number of simultaneous sessions is reached often. This way there are less inactive sessions using up resources.

No modules need to be restarted for changes to this parameter to take effect; clicking Apply at the bottom of the page is sufficient.

Cleanup frequency

The cleanupFrequency parameter defines the time (number of seconds) after which the system checks whether there are sessions on the server to be disconnected. (Sessions to be disconnected are sessions where nothing has happened during the defined timeout period).

The parameter value can be decreased to perform cleanup more often, especially if the timeout is also decreased.

No modules need to be restarted for changes to this parameter to take effect; clicking Apply at the bottom of the page is sufficient.

Connectionless mode

These parameters are related to functions and settings in connectionless mode.

Enabling the secure port

The enableSecurePort parameter defines whether the secure port for connection-oriented mode is enabled (1) or disabled (0). The secure port is used for connections over WTLS, if the end user's WAP terminal supports WTLS. (WTLS is an optional feature.)

When this parameter has been changed, the Core module has to be restarted for the change to take effect.

Enabling the unsecure port

The enableUnsecurePort parameter defines whether the unsecure port for connectionless mode is enabled (1) or disabled (0).

When this parameter has been changed, the Core module has to be restarted for the change to take effect.

Maximum number of connectionless transactions

The maxClessTransactions parameter defines the maximum number (positive integer) of simultaneous transactions in connectionless mode. The maximum number can vary according to the capacity of the system.

No modules need to be restarted for changes to this parameter to take effect; clicking Apply at the bottom of the page is sufficient.

Error messages

These parameters are related to the error messages sent to end users. The LANG 1 subheading indicates the language (English) used for error messages.

Enabling error messages

The enableUserErrorMessages parameter enables (1) or disables (0) sending error messages to end users.

No modules need to be restarted for changes to this parameter to take effect; clicking Apply at the bottom of the page is sufficient.

Code

The CODE parameter defines the language of the error messages.

No modules need to be restarted for changes to this parameter to take effect; clicking Apply at the bottom of the page is sufficient.

Header

The HEADER parameter defines the file from which the error message HTTP header is retrieved. This header is sent to the user's WAP terminal together with the error message.

No modules need to be restarted for changes to this parameter to take effect; clicking Apply at the bottom of the page is sufficient.

Errors

The ERROR 0—ERROR 20 parameters define the files from which error messages are retrieved.

No modules need to be restarted for changes to these parameters to take effect; clicking Apply at the bottom of the page is sufficient.

Default error messages

Several errors (0, 3, 4, 5, 9, 10, 18, 19, and 20) return the default error message “Internal Gateway error”. These messages only occur in extremely rare error situations.

ERROR_{—}1: buffer_exhausted.wml

This error is returned when the content server returns content that is too big for the Gateway's content adapters. The content adapters have an internal size limit for accepted content to avoid memory overloads. The size limit protects the Gateway from denial-of-service attacks resulting from attempts to request overly large content packages.

ERROR_{—}2: parse_error.wml

This error is returned when the content server returns a response in an incorrect format, for example in binary format without headers.

ERROR_{—}6: connect_timeout.wml

This error is returned if the content server does not respond to the connection request within the timeout period defined by the connect timeout parameter.

ERROR_{—}7: connect_refused.wml

This error is returned when the content server refuses the connection from the Gateway. The content server can refuse a connection for various reasons.

ERROR_{—}8: url_lookup.wml

This error is returned when the URL of the requested content server cannot be found.

ERROR_{—}11: compile.wml

This error is returned when the Gateway fails to compile the WML page returned by the content server (the WML format of the page is incorrect).

ERROR_{—}12: header_compile.wml

This error is returned when the Gateway fails to compile HTTP headers returned by the content server into WSP (the header format is incorrect).

ERROR_{—}13: content_toobig.wml

This error is returned when the content returned by the content server is too big for the end user's WAP terminal to handle. The content size limit imposed by the Gateway is significantly larger than that imposed by most WAP terminals, so that content that passes through the Gateway with no trouble (i.e. no ERROR_{—}1) might not be accepted by some WAP terminals.

This error is only available in connection-oriented mode.

ERROR_{—}14: content_format.wml

This error is returned when the response from the content server is in a format that the end user's WAP terminal does not support. The supported formats vary in different terminals.

ERROR_{—}15: no-headers.wml

This error is returned when the content server does not return headers with the response. If headers are missing, the Gateway cannot tell the content type of the response and thus cannot determine whether the WAP terminal would accept the response.

ERROR_{—}16: refused.wml

This error is returned when the Gateway access policy denies the user's access to the requested page. This access control is performed by the Knowledge Base when the end user's bearer address (typically MSISDN) and the requested URL are transmitted through the Gateway to the Knowledge Base, which recognizes that the user in question has no access to the page being requested.

ERROR_{—}17: access_level_failed.wml

This error is returned when the access level defined for the user is not adequate for the requested service.

Dialup accounting server parameters

Depending on the type of bearer network, a data call to a dialup may be required for a terminal to connect to the WAP Gateway. When the WAP terminal makes a data call, the dialup device assigns it an IP address to allow the terminal to communicate with the Gateway. The dialup device then sends the Gateway's dialup accounting server a message that specifies the MSISDN of the WAP terminal and the assigned IP address.

The request from the WAP terminal is sent to the Gateway Core. Based on the terminal's temporary IP address, the Core sees where the request is coming from and queries the dialup accounting server for the corresponding MSISDN. The Core uses the MSISDN to query the Knowledge Base for user information needed for billing and logging.

Parameters under the Dialup accounting server section affect the functioning of the dialup accounting server.

The address resolver parameters under the Core section also affect the dialup accounting server. In version 1.1 of the Gateway, the dialup accounting server functions as the address resolver.

Ports

These parameters define the ports used by the dialup accounting server.

Radius port

The RADIUS protocol is used by the dialup device to communicate with the dialup accounting server. The radius port parameter defines the port on which the dialup accounting server listens to the dialup device.

When this parameter has been changed, the Dialup accounting server module has to be restarted for the change to take effect.

Dialup accounting RPC port

The dacct rpc parameter defines the port used by the dialup accounting server to communicate with the Core. The parameter value has the format protocol:machine_name:port_number. The machine name is the machine where the dialup accounting server is located.

When this parameter has been changed, the Dialup accounting server module has to be restarted for the change to take effect.

Dialups

The dialup accounting server receives information from dialup devices. Various networks can use different formats for MSISDNs, and each network's dialup device returns MSISDNs in the format used by the network. Each MSISDN format requires its own set of rules for conversion to the absolute format understood by the Gateway. The Gateway's dialup configuration file describes how to interpret the information received from dialup devices.

The dialup configuration file is a text file that may contain blank lines and comments. Lines whose first non-blank character is a pound sign (#) are interpreted as comments. Each line can contain a configuration parameter or a dialup device IP address. Parameters are identified by case-sensitive keywords (radius_secret and msisdn_rules) and they apply to the dialup device IP addresses following them. The IP addresses must be unique (the same address cannot appear twice in the dialup configuration file). Sets of rules are separated by blank lines.

The following is an example of configuration file text:

# Two boxes in one network . . .

radius_secret foo

msisdn_rules /^{Λ}00+//^{Λ}([^{Λ}0\+])/+3589\1/

10.0.0.10

10.0.0.11

# . . . and two in another (they also use a different password)

radius_secret bar

msisdn_rules /^{Λ}00([^{Λ}0])/+\1//^{Λ([}^{Λ}0\+])/+35850\1/

10.0.0.20

10.0.0.21

The MSISDN rules are similar to replacement commands implemented by common UNIX utilities (e.g. the ed ‘s’ command), but with no qualifying expression to determine whether a rule should apply. All rules are always applied if the regular expression part matches, but not necessarily in order. Each rule consists of a regular expression (an extended regular expression as defined by POSIX 1003.2, section 2.8, Regular Expression Notation) and a replacement string. A rule begins and ends with a slash, and different parts are also delimited by slashes. The regular expression may contain parenthesized subexpressions (using unescaped parentheses). The replacement string can refer to these parenthesized subexpressions with a backslash followed by a number.

Parameters for specific IP addresses in the configuration file override the defaults specified in the Configuration Editor. The defaults are sufficient if it is known that all dialup devices from which connections are made to the Gateway are configured identically.

Default RADIUS secret

The def radius secret parameter defines the default secret (also called password or key) used by the dialup accounting server and the dialup device to identify each other. The same password must also be configured in the dialup device.

No modules need to be restarted for changes to this parameter to take effect; clicking Apply at the bottom of the page is sufficient.

Default MSISDN rules

The def msisdn rules parameter defines the default rules used for converting MSISDNs to the format used by the Gateway. The accepted format consists of the entire MSISDN. The MSISDN is expressed in a maximum of 15 characters: a plus sign (+) followed by a maximum of 14 digits. Any other formats used in different networks are converted to this format according to rules defined in this parameter and in the dialup configuration file.

No modules need to be restarted for changes to this parameter to take effect; clicking Apply at the bottom of the page is sufficient.

Dialup configuration file name

The extra config parameter defines the name of the dialup configuration file. The directory path for the file is /wapgw/gateway/acct_server/.

No modules need to be restarted for changes to this parameter to take effect; clicking Apply at the bottom of the page is sufficient.

SSL proxy

Parameters under the SSL Proxy section affect the SSL proxy in the Gateway.

Cipher list

The cipher list parameter defines which encryption algorithms the SSL proxy accepts and their order of preference. All algorithms containing authentication are accepted.

The value “!ADH:HIGH:MEDIUM:LOW:EXP” is used by the OpenSSL library. For detailed information on the meaning of possible settings, consult the OpenSSL or SSLeay documentation, which is freely available. It is unlikely that the parameter value will have to be changed.

If this parameter has been changed, the SSL Proxy module has to be restarted for the change to take effect.

Debug mode

The debug mode parameter defines how much SSL proxy information is logged. This parameter enables (1) or disables (0) the debug mode.

When this parameter has been changed, the SSL Proxy module has to be restarted for the change to take effect.

Session expiration time

Connections from the Gateway to content servers are made through the SSL proxy. Data from content servers is returned through HTTP adapters. This data includes HTTP headers, which contain a session ID that can be used to request the content server's certificate.

The sess expire time parameter defines the time (number of seconds) that the content server's certificate and other information is stored.

When this parameter has been changed, the SSL Proxy module has to be restarted for the change to take effect.

Log file

The log file parameter defines the location of the SSL proxy log file. This file is internal and does not need to be viewed by the system administrator.

When this parameter has been changed, the SSL Proxy module has to be restarted for the change to take effect.

Listen port

The listen port parameter defines the port used by the SSL proxy to listen for connections from HTTP adapters.

When this parameter has been changed, the SSL Proxy module has to be restarted for the change to take effect.

The configurations on dialup devices that communicate with the Gateway need to be modified so that RADIUS accounting data is sent to the Gateway's dialup accounting server. The dialup device password must also match the password in the Gateway configuration file (the radius_secret parameter for the dialup device's IP address).

On the front page of the Configuration Editor there are links to the five sections:

Knowledge base admin: The administration interface of the Knowledge Base

Knowledge base core: The database section of the Knowledge Base

Core: The central part of the Gateway that handles sessions and transactions

Dialup accounting server: The address resolver

SSL proxy: The module that handles secure sessions

The Configuration page displays the current values for all configuration parameters in text boxes.

The Administration Console can be used for more than just system maintenance. It is the primary tool for managing user accounts and subscriptions, as well as services.

Users and groups are basically managed in the same way. The differences are firstly that users can be members of groups, and secondly that groups can be either ordinary groups or organizations.

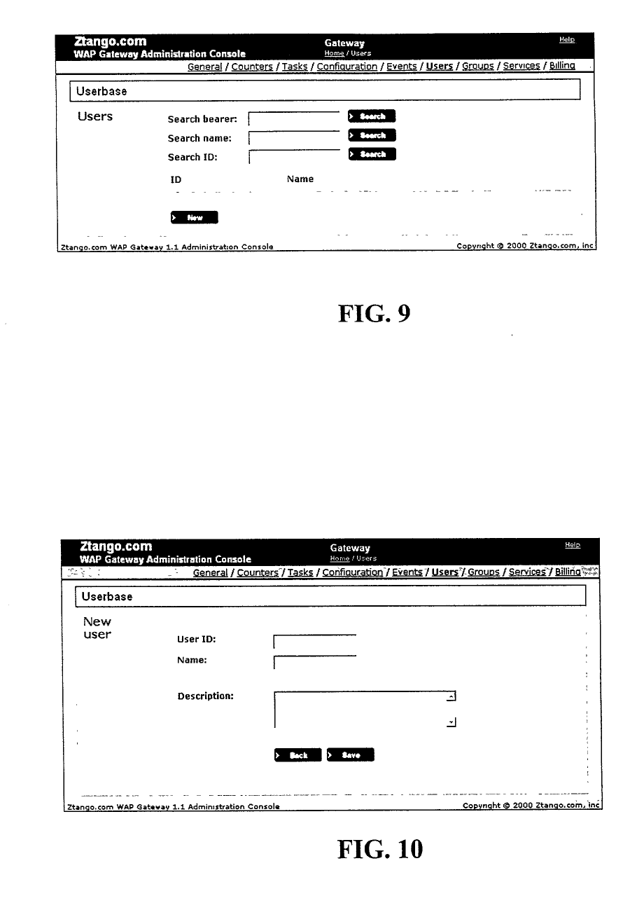

User, group and service management concerns the Knowledge Base module of the WAP Gateway. On both the Users and the Groups pages, three text boxes are displayed, as illustrated in FIG. 9:

Search bearer: Enter the user's WAP terminal's bearer address (telephone number or IP address) to find the user in the database

Search name: Enter the user's name to find the user in the database

Search ID: Enter the user's or group's unique identifier to find the user in the database

To find a user or a group in the database, the administrator enters the user's or group's (if an organization) bearer network address in the Search bearer text box. The format for GSM numbers (MSISDN) is the international format without spaces (+nnnnnnnnnnnnnnn=15 characters); the format for IP addresses is the standard n.n.n.n format. Alternatively, on the Users/Groups page, the administrator can enter the user's or group's name either in its entirety (Susan User) or with wildcards (Susan Us*) in the Search name text box. Finally, the administrator can enter the user's or group's unique identifier in the Search ID text box, as follows:

1 Next to the text box which was edited, click Search. A list of the users/groups that match the query is displayed.

2 To view the user's/group's information, click the ID of the user/group in the list. The user's User page or the group's Group page is displayed.

To add a user or a group, the administrator can go to an empty User or Group page and provide the gateway with information about the user or group, as follows and as shown in FIG. 10:

1 On the Users/Groups page, click New.

2 In the ID text box, provide an ID number for the user or group. If the box is left blank, the Knowledge Base will automatically assign an ID. After creating the user or group, the ID cannot be edited.

3 In the Name text box, enter the user's or group's name.

4 In the Description text box, enter freeform notes about the user or group (optional).

5 Click Save.

6 Click Ok.

Clicking Back twice at this point takes the user back to the New User page where the administrator can continue to modify the user account by clicking each link in turn: Bearer addresses, Subscriptions, Groups and Aliases. When the information required on each page is provided, the user can click Back again to return to the user's New User page.

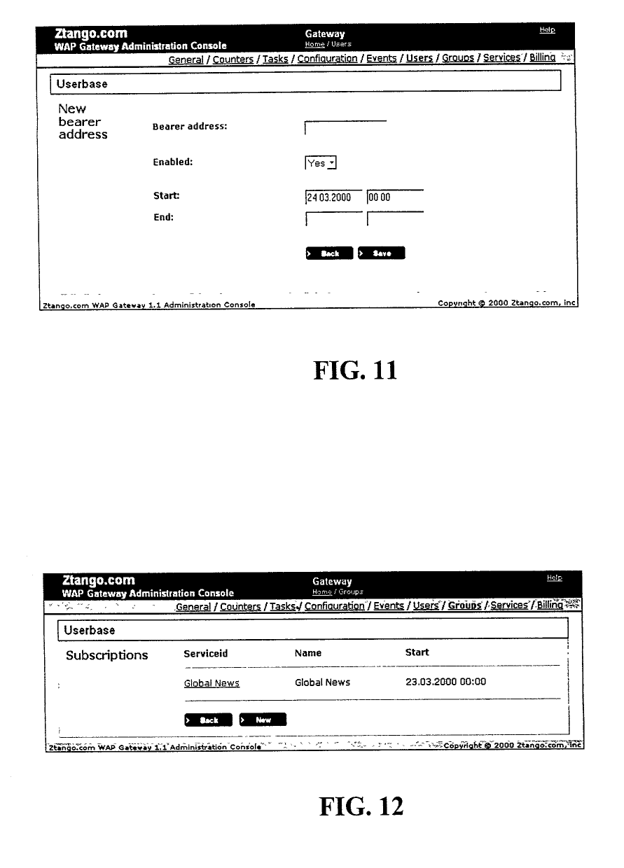

In order to provide the bearer address, the following steps are taken, as shown in FIG. 11:

1 Click the Bearer addresses link.

2 Click New.

3 Enter the user's or group's bearer address.

4 To enable authentication for this number, select Yes in the Enabled drop-down box.

5 In the Start text boxes, enter the date and time when the number becomes valid.

6 In the End text boxes, enter the date and time when the number ceases to be valid. The format for GSM numbers is the international format without spaces between numbers (+nnnnnnnnnnnnnn=15 characters). The format for IP addresses is the standard n.n.n.n format.

7 Click Save.

8 Click Ok.

To set service subscriptions, the following steps are taken, as shown in FIG. 12:

1 Find the user or group in the database.

2 Click the Subscriptions link. The user's or group's Subscriptions page opens.

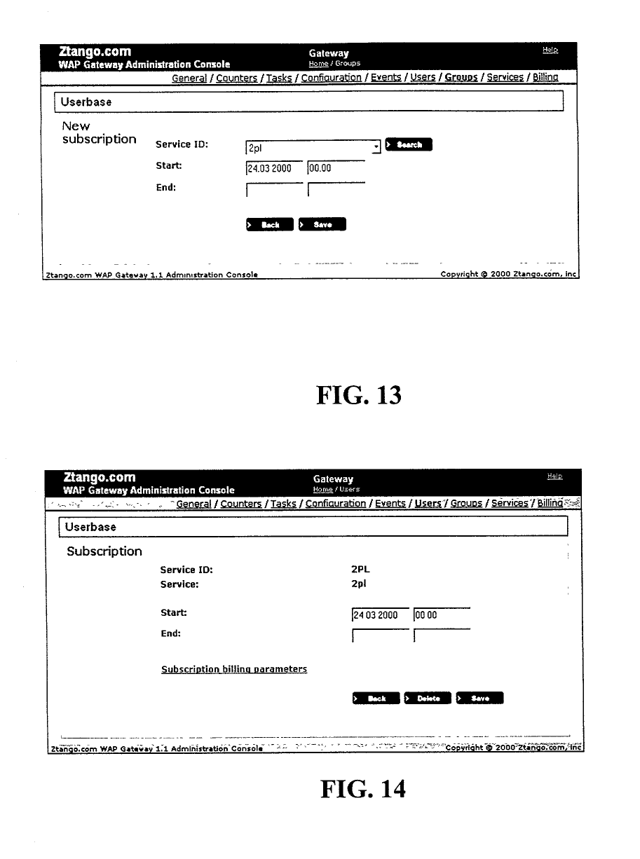

3 Click New. The New subscription page opens (FIG. 13).

4 On the Service ID drop-down list, find the service to subscribe the user or group to.

5 In the Start text box, enter first the date and then the time when the subscription becomes valid.

6 In the End text box, enter first the date and then the time when the subscription ceases to be valid. The date format is dd.mm.yyyy and the time format is hh:mm.

7 Click Save.

8 Click Ok.

To view and edit an existing subscription, the following steps are taken:

1 Find the user or group in the database.

2 Click the Subscriptions link. The Subscriptions page opens, displaying a list of subscriptions.

3 In the list of subscriptions, click the subscription to be viewed or modified. The subscription's edit page opens, as seen in FIG. 14.

To add a billing parameter for a subscription, the following steps are taken:

1 Find the user or group in the database.

2 Click the Subscriptions link. The Subscriptions page opens, displaying a list of subscriptions.

3 In the list of subscriptions, click the subscription to be viewed or modified. The subscription's edit page opens.

4 Click the Subscription billing parameters link. A list of the subscription's billing parameters is displayed. If the subscription is new, the list is empty.

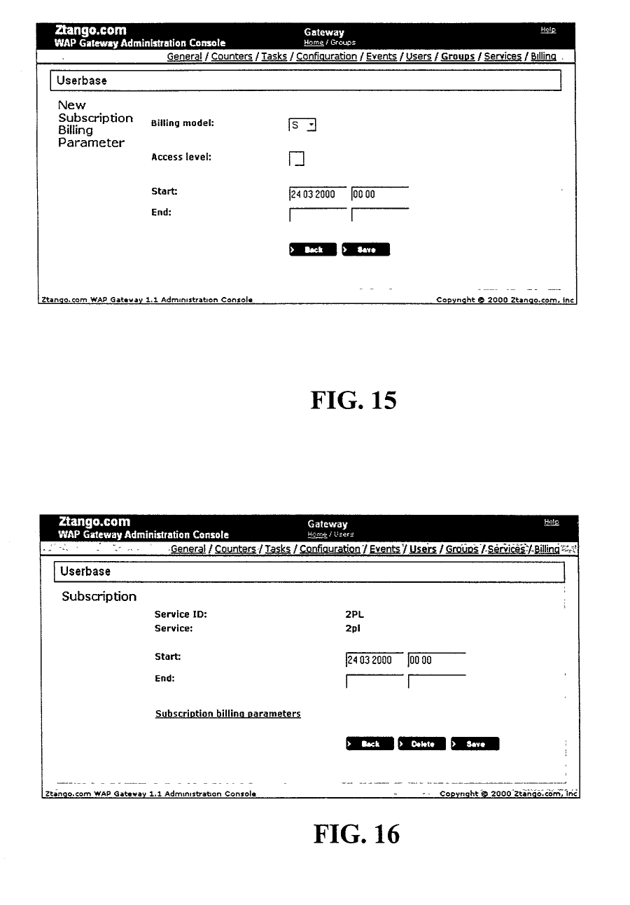

5 Click New. The New Subscription Billing Parameter page opens, as illustrated in FIG. 15.

6 In the Billing model drop-down box, select a billing model.

7 In the Access level drop-down box, select an access level for the user. The Access level drop-down box is available only if the service that is being subscribed to uses access level control.

8 In the Start text boxes, enter the date and the time when the subscription becomes valid.

9 In the End text boxes, enter the date and the time when the subscription ceases to be valid.

10 Click Save.

11 Click Ok.

The system also permits administrators to define payers and payment methods for each service subscription that a user or a group has. These options must be defined so that only one set is valid at a time. To set a subscription's billing options, the following steps are taken, as seen in FIG. 16:

12 Find the user or group in the database.

13 Navigate to the subscription to be modified.

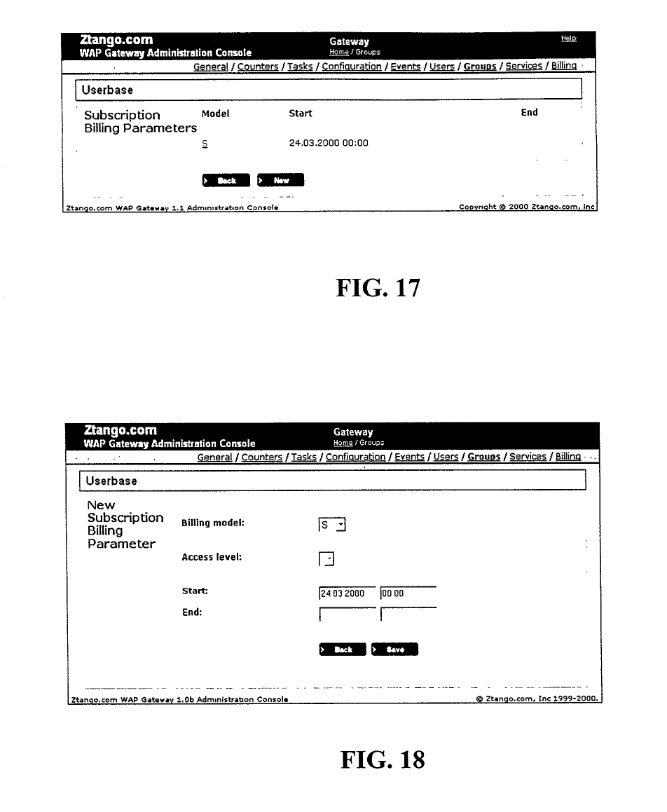

14 Click the Subscription billing parameters link. The user's Subscription Billing Parameters page opens, seen in FIG. 17.

15 Click New. The New Subscription Parameter page opens FIG. 18).

16 In the Billing model drop-down box, select the billing model to be applied to the subscription.

17 If access level control has been enabled for the service in question, select an access level for the user or group.

18 In the Start text boxes, enter the date and the time when the billing parameter becomes valid.

19 In the End text boxes, enter the date and the time when the billing parameter ceases to be valid.

20 Click Save.

21 Click Ok.

The billing models where the payment method is a phone bill allow the definition of a payer who is different from the user (or group) who actually subscribes to the service. Under such a scenario, the payer must be a user with a user account in the Knowledge Base.

To define a payer, the following steps are undertaken:

1 Find the user or group in the database.

2 Navigate to the subscription to be modified.

3 Create a new subscription billing parameter, selecting a billing model with phone bill defined as the payment method.

4 Click Save.

5 Click Ok. The Edit Subscription Billing Parameter page opens.

6 In the Payer ID text box, enter the ID of the user to be defined as payer or click Browse to locate the payer in the Knowledge Base.

7 Click Save.

8 Click Ok.

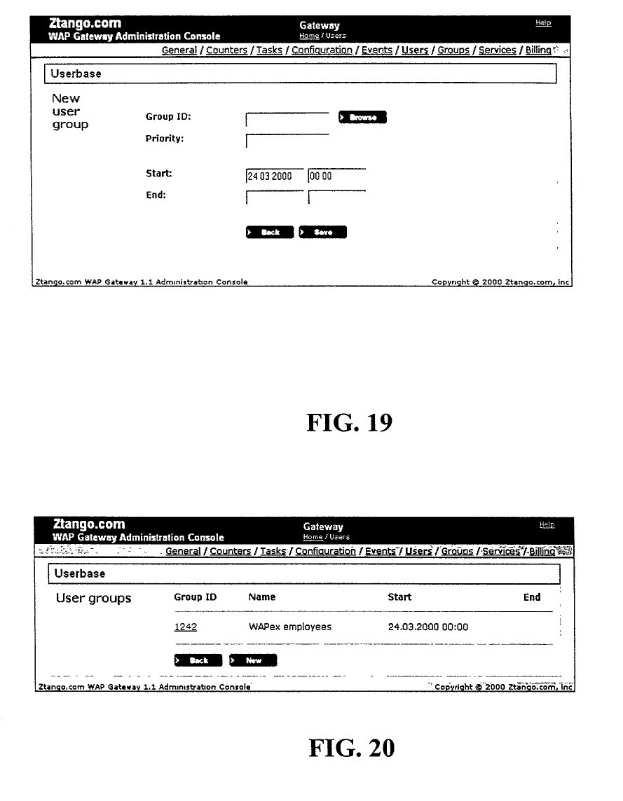

Once groups are created, users can be added to groups, as follows and as illustrated in FIG. 19:

1 Find the user in the database.

2 Click Groups. The user's Groups page opens.

3 Click New. The New user group page opens.

4 In the Group ID text box, enter the ID of the group to add the user to.

5 In the Priority text box, enter a numerical value from 1 to 999 that describes the priority of the membership.

6 In the Start text boxes specify the date and the time when the group membership becomes valid.

7 In the End text boxes, specify the date and the time when the group membership ceases to be valid.

8 Click Save.

9 Click Ok.

To view an existing group membership or edit the time frame, the following steps are taken, as pictured in FIG. 20:

1 Find the user in the database.

2 Click the Groups link. The user's User groups page opens.

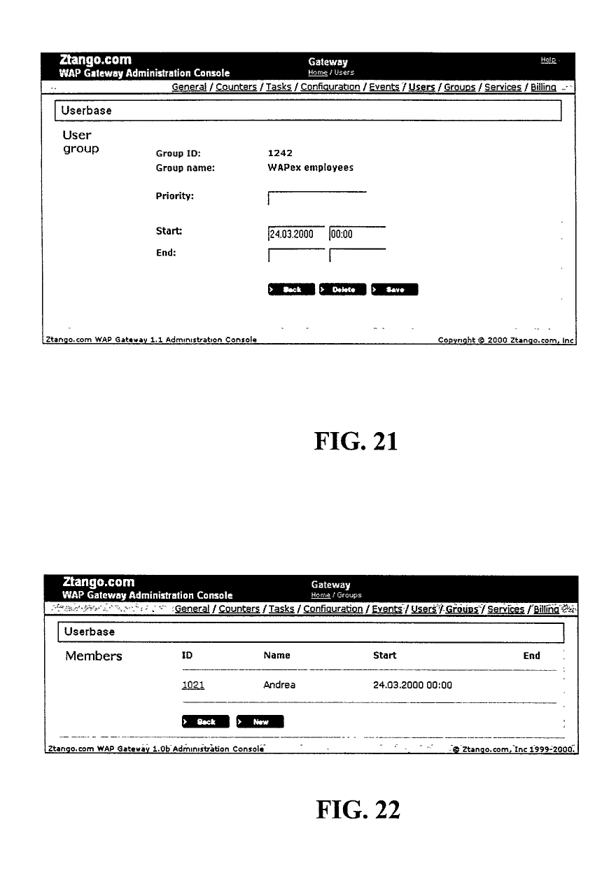

3 In the link list, click a group ID. The User group page opens (FIG. 21)

It is also possible to view all the memberships attached to a specific group, and edit each individual membership through the group's pages, by taking the following steps, also illustrated in FIG. 22:

1 Find the group in the database.

2 Click Members. The group's Members page opens.

3 Click New. An empty Group member page opens.

4 In the User ID text box, enter the ID of the user to add as a member. To find users in the Knowledge Base, click Browse.

5 In the Priority text box, enter a number from 1 to 999.

6 In the Start text boxes, enter the date and the time when the membership becomes valid.

7 In the End text boxes, enter the date and the time when the membership ceases to be valid.

8 Click Save.

9 Click Ok.

In order to view or edit a group's members, the following steps are taken:

1 Find the group in the database.

2 Click the Members link. The group's Members page opens, displaying a list of the group's members.

3 To edit a member, click the member's ID in the list and modify the membership properties.

The system also permits for users and groups to have specific aliases only for their use.

To edit user or group level aliases, these steps are taken:

1 Find the user or group in the database (see section Error! Reference source not found.).

2 Click the Aliases link. The user's or group's Aliases page opens.

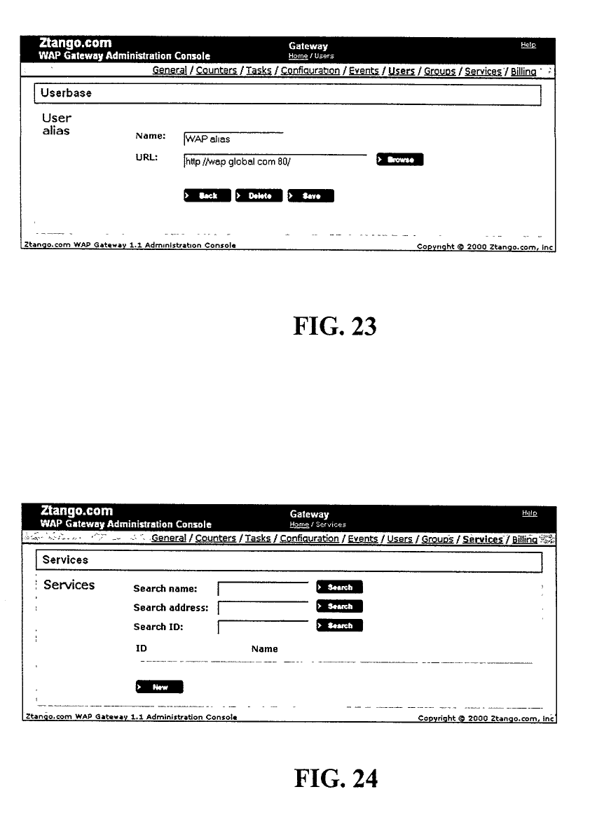

3 Click an existing alias in the link list or click New. The User alias page opens (FIG. 23).

4 In the Name text box, enter a name for the alias.

5 In the URL text box, enter the URLs for the alias. The URL is case-sensitive. Alternatively, click Browse to search for the URL in the list of URLs already added to the Gateway.

6 Click Save.

7 Click Ok.

In order for service providers to be able to charge for the use of their services, the services must be added to the Gateway service selection, using the Services page, depicted in FIG. 24.

In order to view existing services, three options are provided:

Search name: Enter the service's name to find the service in the database

Search address: Enter the service's URL to find the service in the database

Search ID: Enter the service's unique identifier to find the service in the database

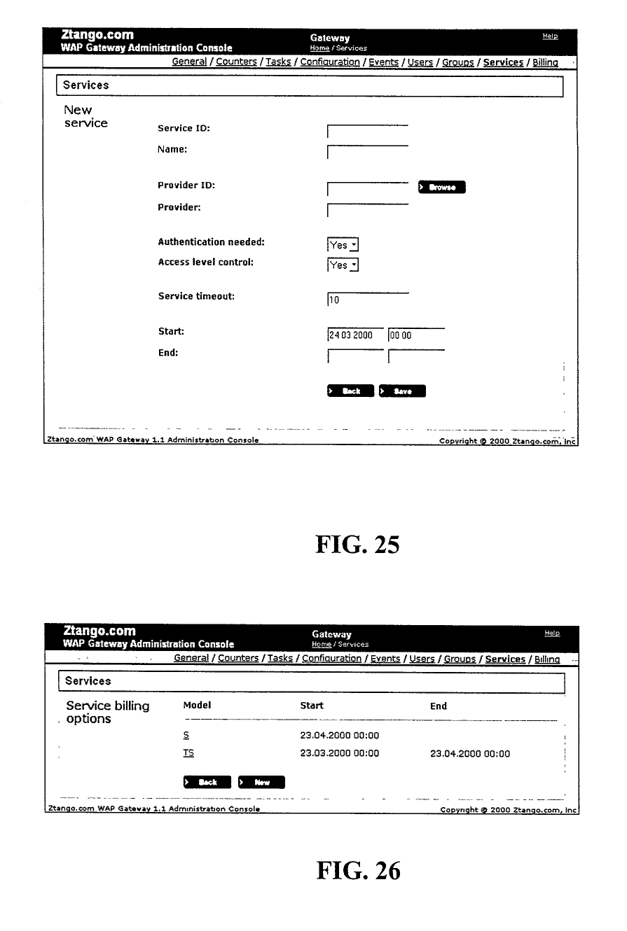

It is also possible to add a service to the Gateway's service selection, by going to an empty Service page and providing the service's contact, billing and pricing information for the Gateway, as follows and as shown in FIG. 25:

1 On the Services page, click New. The New service page opens.

2 In the Service ID text box, enter a unique identifier for the service. If the box is left blank, the Gateway automatically provides an ID.

3 In the Name text box, enter a name for the service.

4 In the Provider ID text box, enter the identifier of the service provider or click Browse to find the ID in the Knowledge Base.

5 Once the Provider ID is entered, the provider's name appears automatically in the Provider text box for verification.

6 In the Authentication needed drop-down box, select Yes to require authentication for this service.

7 In the Access level control drop-down box, select Yes to enable access levels for this service.

8 In the Timeout text box, enter the number of seconds that the service should wait for activity by the connecting end user before closing the connection.

9 In the Start text boxes, enter the date and the time when the service becomes available for end users. (The default is midnight on the current day.)

10 In the End text boxes, enter the date and the time when the service stops being available for end users.

11 Click Save.

12 Click Ok.

A service's billing options consist of the billing models chosen for the service and the time that each billing model is valid. A billing model, in turn, consists of two variables: price and billing criteria.

To define service billing options, the following steps are taken, as FIG. 26:

1 On the New service or Edit service page, click the Billing Options link. A list of the service's billing options is displayed. If the service is new, the list is empty.

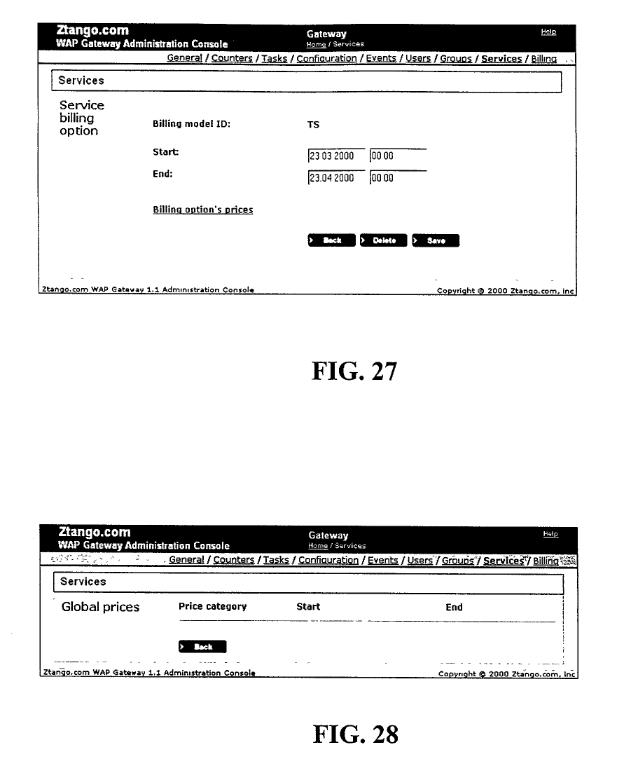

2 To modify a billing option, click its Model in the list or click New. The Service billing option page opens. What appears on the page depends on the model of the option being edited. If the service's Billing model uses global pricing, the Global prices link appears. If the service uses individual prices, the Billing option's prices link appears (FIG. 27).

3 Modify the Start and End text boxes as desired.

4 Click Save.

5 Click Ok.

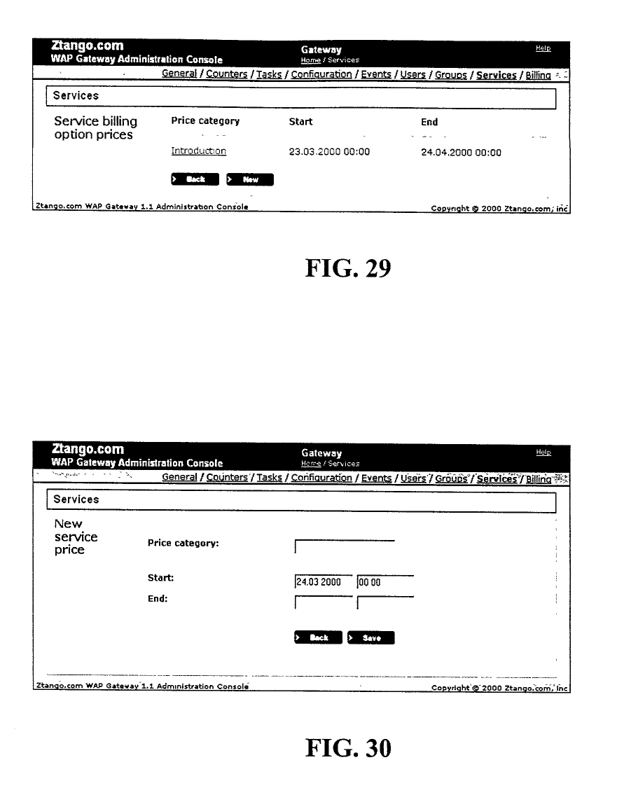

To view and edit prices, the following steps are taken, as seen in FIGS. 28 and 29:

1 On the Service billing option page, click the Global prices or Billing option's prices link. A list of prices is displayed.

2 To edit a price category, click it in the list or on the Service billing option prices page, click New (FIG. 30).

3 In the Price category text box, enter a name for the price category.

4 In the Start text boxes, specify the date and the time when the price becomes valid.

5 In the End text boxes, specify the date and the time when the price ceases to be valid.

6 Click Save.

7 Click Ok.

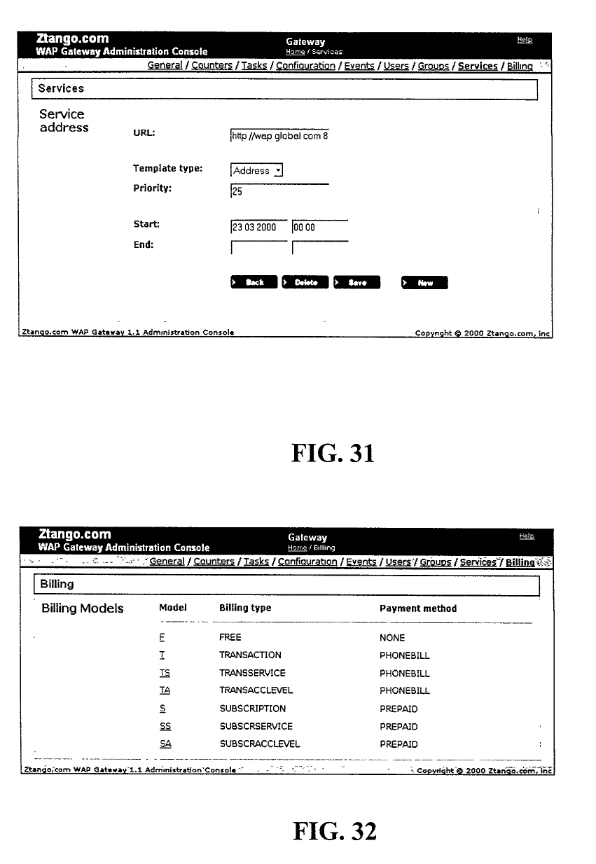

Through the Addresses link the URLs that have been defined for each service can be added and edited, as shown in FIG. 31:

1 On the Edit service page, click the Addresses link. A list opens, displaying the URLs that have been defined for the service.

2 Click an address on the list or click New.

3 In the URL text box, enter the URL for the service. Also include the port number.

4 In the Template type drop-down box, select Address or Wildcard.

5 In the Priority text box, enter a number between 1 and 999. If the box is left blank, the Knowledge Base calculates a priority according to the number of characters in the URL.

6 In the Start text boxes, enter the date and the time when the URL becomes available for end users.

7 In the End text boxes, enter the date and the time when the URL stops being available for end users.

8 Click Save.

9 Click Ok.

Global prices are prices defined for billing models. One billing model can include several price categories. Global prices are edited through the Billing page, as shown in FIG. 32:

1 In the Administration Console, click Billing. The Billing page opens, displaying a list of available global billing models.

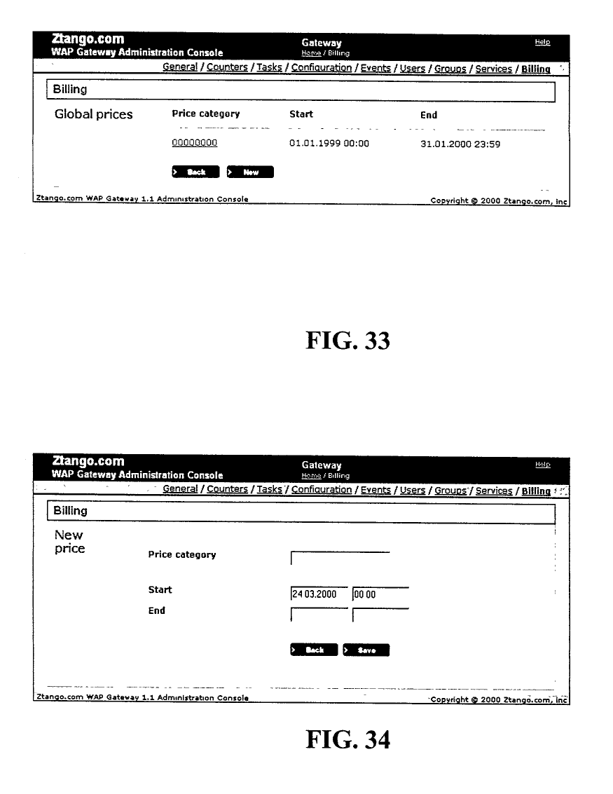

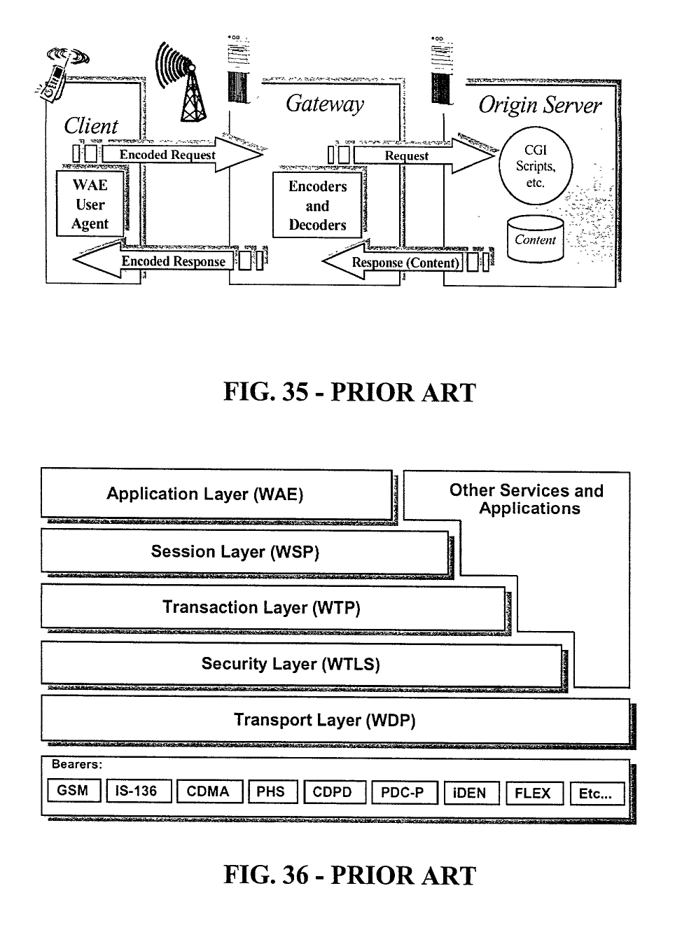

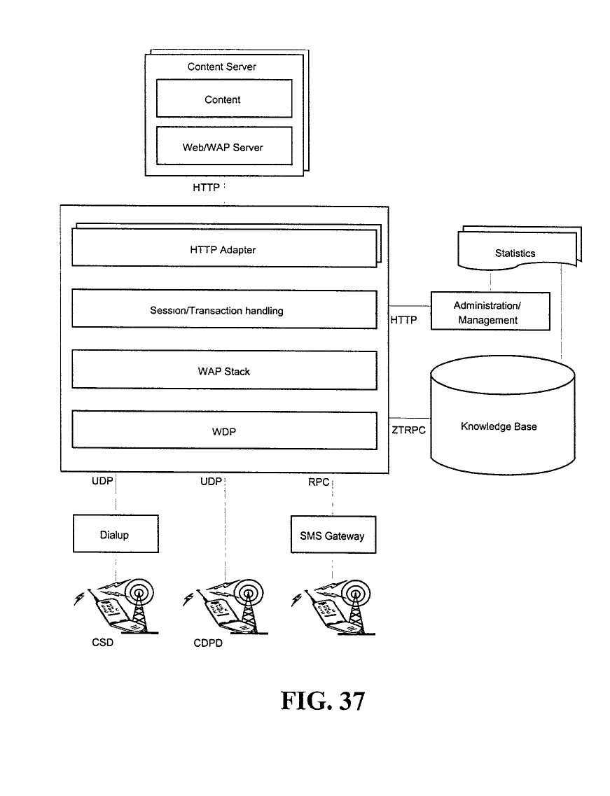

2 In the list, click the billing model to modify. The model's Global prices page opens (FIG. 33).

3 To edit a price category, click it in the list or click New (FIG. 34).

4 In the Price category text box, enter a name for the price category.

5 In the Start text boxes, specify the date and the time when the price becomes valid.

6 In the End text boxes, specify the date and the time when the price ceases to be valid.

7 Click Save.

8 Click Ok.

Accordingly, it will be understood that the preferred embodiment of the present invention has been disclosed by way of example and that other modifications and alterations may occur to those skilled in the art without departing from the scope and spirit of the appended claims.

What is claimed is:

1. A system for providing information over a Wireless Application Protocol Gateway, comprising:
at least one Access Point;
a Core;
a Knowledge Base;
an Administrative Console;
a Statistics Module; and,
at least one Content Server.

2. The system of claim 1, wherein said Access Point enables consumers to connect to said gateway.

3. The system of claim 2, wherein said Access Point is utilized in a Circuit Switched Data network, whereby incoming traffic from said network is directed through a dialup server over User Datagram Protocol.

4. The system of claim 1, wherein said Access Point is utilized in a Short Message Service network.

5. The system of claim 1, wherein said Core transmits requests from consumers to said Content Servers on a global network of computers, and data from said Content Servers back to the consumers.

6. The system of claim 1, wherein said Core is comprised of content adapters, session/transaction handling modules, WAP Stack modules, and Wireless Datagram Protocol modules.

7. The system of claim 6, wherein said content adapters are interchangeable for version and new protocol upgrades.

8. The system of claim 6, wherein said WAP Stack, through binary encoding and decoding, handles all content transmissions, retransmissions, and acknowledgements related to connections between said Gateway and the consumer.

9. The system of claim 1, wherein said Core is in operative communication with said Knowledge Base, said Administrative Console, said Content Servers and said Access Points.

10. The system of claim 1, wherein said Statistics Module is in operative communication with said Core via said Administrative Console.

11. The system of claim 1, wherein said Knowledge Base is a database that contains service definitions and individual user data.

12. The system of claim 11, wherein said Knowledge Base also saves details of all sessions and transactions in logs that are used to create billing data.

13. The system of claim 1, wherein said Core communicates with said Knowledge Base for necessary user information such as service plan, billing, and user preferences.

14. The system of claim 1, wherein said Administrative Console is a web-based user interface for administration and management of said Gateway.

15. The system of claim 14, wherein said Administrative Console also displays system events and the alerts resulting from said events.

16. The system of claim 14, wherein said Administrative Console utilizes said Statistics Module to display system statistics reflecting the amount and type of traffic at each Gateway interface.

17. The system of claim 1, wherein said Statistics Module consists of various counters that monitor different values related to the system status, such as the number of sessions and transactions, memory usage, and system uptime.

18. The system of claim 17, wherein values of said counters are logged regularly in a separate file for retrieval and viewing.

19. The system of claim 1, wherein said Content Servers can be located on the Internet or in a local network.

20. A system for providing information over a wireless application protocol gateway in a Cellular Digital Packet Data network, with static Internet Protocol addressing, comprising:
a Core;
a Knowledge Base;
an Administrative Console;
a Statistics Module; and,
at least one Content Server.

21. The system of claim 20, whereby said said network enables consumers to connect to said gateway directly over User Datagram Protocol.

22. The system of claim 20, wherein said Core transmits requests from consumers to said Content Servers on a global network of computers, and data from said Content Servers back to the consumers.

23. The system of claim 20, wherein said Core is comprised of content adapters, session/transaction handling modules, WAP Stack modules, and Wireless Datagram Protocol modules.

24. The system of claim 23, wherein said content adapters are interchangeable for version and new protocol upgrades.

25. The system of claim 23, wherein said WAP Stack, through binary encoding and decoding, handles all content transmissions, retransmissions, and acknowledgements related to connections between said Gateway and the consumer.

26. The system of claim 20, wherein said Core is in operative communication with said Knowledge Base, said Administrative Console, and said Content Servers.

27. The system of claim 20, wherein said Statistics Module is in operative communication with said Core via said Administrative Console.

28. The system of claim 20, wherein said Knowledge Base is a database that contains service definitions and individual user data.

29. The system of claim 28, wherein said Knowledge Base also saves details of all sessions and transactions in logs that are used to create billing data.

30. The system of claim 20, wherein said Core communicates with said Knowledge Base for necessary user information such as service plan, billing, and user preferences.

31. The system of claim 20, wherein said Administrative Console is a web-based user interface for administration and management of said Gateway.

32. The system of claim 31, wherein said Administrative Console also displays system events and the alerts resulting from said events.

32. The system of claim 31, wherein said Administrative Console utilizes said Statistics Module to display system statistics reflecting the amount and type of traffic at each Gateway interface.

33. The system of claim 20, wherein said Statistics Module consists of various counters that monitor different values related to the system status, such as the number of sessions and transactions, memory usage, and system uptime.

34. The system of claim 33, wherein values of said counters are logged regularly in a separate file for retrieval and viewing.

35. The system of claim 20, wherein said Content Servers can be located on the Internet or in a local network.

36. A system for providing information over a Wireless Application Protocol Gateway, comprising:
at least one Access Point, wherein said Access Point enables consumers to connect to said gateway and further is utilized in a Circuit Switched Data network, whereby incoming traffic from said network is directed through a dialup server over User Datagram Protocol;
a Core, wherein said Core transmits requests from consumers to said Content Servers on a global network of computers, and data from said Content Servers back to the consumers, said Core comprised of content adapters, session/transaction handling modules, WAP Stack modules, and Wireless Datagram Protocol modules;
a Knowledge Base, wherein said Knowledge Base is a database that contains service definitions and individual user data, said Knowledge Base farther saving details of all sessions and transactions in logs that are used to create billing data;
an Administrative Console, wherein said Administrative Console is a web-based user interface for administration and management of said Gateway;
a Statistics Module, wherein said Statistics Module is in operative communication with said Core via said Administrative Console, said Statistics Module consisting of various counters that monitor different values related to the system status, such as the number of sessions and transactions, memory usage, and system uptime; and,
at least one Content Server, wherein said Content Server can be located on the Internet or in a local network.

37. The system of claim 36, wherein said Access Point is utilized in a Short Message Service network.

38. The system of claim 36, wherein said content adapters are interchangeable for version and new protocol upgrades.

39. The system of claim 36, wherein said WAP Stack, through binary encoding and decoding, handles all content transmissions, retransmissions, and acknowledgements related to connections between said Gateway and the consumer.

40. The system of claim 36, wherein said Core is in operative communication with said Knowledge Base, said Administrative Console, said Content Servers and said Access Points.

41. The system of claim 36, wherein said Core communicates with said Knowledge Base for necessary user information such as service plan, billing, and user preferences.

42. The system of claim 36, wherein said Administrative Console also displays system events and the alerts resulting from said events.

43. The system of claim 36, wherein said Administrative Console utilizes said Statistics Module to display system statistics reflecting the amount and type of traffic at each Gateway interface.

44. The system of claim 36, wherein values of said counters are logged regularly in a separate file for retrieval and viewing.

45. A system for providing information over a wireless application protocol gateway in a Cellular Digital Packet Data network, with static Internet Protocol addressing, comprising:
a Core, wherein said Core transmits requests from consumers to said Content Servers on a global network of computers, and data from said Content Servers back to the consumers, said Core comprised of content adapters, session/transaction handling modules, WAP Stack modules, and Wireless Datagram Protocol modules;
a Knowledge Base, wherein said Knowledge Base is a database that contains service definitions and individual user data, said Knowledge Base further saving details of all sessions and transactions in logs that are used to create billing data;
an Administrative Console, wherein said Administrative Console is a web-based user interface for administration and management of said Gateway;
a Statistics Module, wherein said Statistics Module is in operative communication with said Core via said Administrative Console, said Statistics Module consisting of various counters that monitor different values related to the system status, such as the number of sessions and transactions, memory usage, and system uptime; and,
at least one Content Server, wherein said Content Server can be located on the Internet or in a local network.

46. The system of claim 45, whereby said network enables consumers to connect to said gateway directly over User Datagram Protocol.

47. The system of claim 45, wherein said Access Point is utilized in a Short Message Service network.

48. The system of claim 45, wherein said content adapters are interchangeable for version and new protocol upgrades.

49. The system of claim 45, wherein said WAP Stack, through binary encoding and decoding, handles all content transmissions, retransmissions, and acknowledgements related to connections between said Gateway and the consumer.

50. The system of claim 45, wherein said Core is in operative communication with said Knowledge Base, said Administrative Console, and said Content Servers.

51. The system of claim 45, wherein said Core communicates with said Knowledge Base for necessary user information such as service plan, billing, and user preferences.

52. The system of claim 45, wherein said Administrative Console also displays system events and the alerts resulting from said events.

53. The system of claim 45, wherein said Administrative Console utilizes said Statistics Module to display system statistics reflecting the amount and type of traffic at each Gateway interface.

54. The system of claim 45, wherein values of said counters are logged regularly in a separate file for retrieval and viewing.

55. A system for providing information over a Wireless Application Protocol Gateway, comprising:
a Core;
an Administrative Console;
a Statistics Module; and,
at least one Content Server.

56. The system of claim 55, wherein said system further comprises an Access Point enabling consumers to connect to said gateway.

57. The system of claim 56, wherein said Access Point is utillized in a Circuit Switched Data network, whereby incoming traffic from said network is directed through a dialup server over User Datagram Protocol.

58. The system of claim 56, wherein said Access Point is utilized in a Short Message Service network.

59. The system of claim 55, wherein said system communicates with consumers over a Cellular Digital Packet Data network, with static Internet Protocol addressing, said network enabling consumers to connect to said Gateway directly over User Datagram Protocol.

60. The system of claim 55, wherein said Core transmits requests from consumers to said Content Servers on a global network of computers, and data from said Content Servers back to the consumers.

61. The system of claim 55, wherein said Core is comprised of content adapters, session/transaction handling modules, WAP Stack modules, and Wireless Datagram Protocol modules.

62. The system of claim 61, wherein said content adapters are interchangeable for version and new protocol upgrades.

63. The system of claim 61, wherein said WAP Stack, through binary encoding and decoding, handles all content transmissions, retransmissions, and acknowledgements related to connections between said Gateway and the consumer.

64. The system of claim 55, further comprising a Knowledge Base, wherein said Knowledge Base is a database that contains service definitions and individual user data.

65. The system of claim 64, wherein said Knowledge Base also saves details of all sessions and transactions in logs that are used to create billing data.

66. The system of claim 55, wherein said Statistics Module is in operative communication with said Core via said Administrative Console.

67. The system of claim 55, wherein said Core communicates with said Knowledge Base for necessary user information such as service plan, billing, and user preferences.

68. The system of claim 55, wherein said Administrative Console is a web-based user interface for administration and management of said Gateway.

69. The system of claim 68, wherein said Administrative Console also displays system events and the alerts resulting from said events.

70. The system of claim 68, wherein said Administrative Console utilizes said Statistics Module to display system statistics reflecting the amount and type of traffic at each Gateway interface.

71. The system of claim 55, wherein said Statistics Module consists of various counters that monitor different values related to the system status, such as the number of sessions and transactions, memory usage, and system uptime.

72. The system of claim 71, wherein values of said counters are logged regularly in a separate file for retrieval and viewing.

73. The system of claim 55, wherein said Content Servers can be located on the Internet or in a local network.
